(19) United States
(12) Patent Application Publication
(10) Pub. No.: US 2007/0003836 A1
(43) Pub. Date: Jan. 4, 2007

(54) Composite particle for electrode and method for producing same, electrode and method for producing same, and electrochemical device and method for producing same

(75) Inventors: Tadashi Suzuki, Tokyo (JP); Masato Kurihara, Tokyo (JP); Satoshi Maruyama, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/556,567

(22) PCT Filed: May 14, 2004
(86) PCT No.: PCT/JP04/06879

§ 371 Date: Dec. 16, 2005

(30) Foreign Application Priority Data
May 14, 2003 (JP) 2003136270
Jul. 3, 2003 (JP) 2003270720
Aug. 29, 2003 (JP) 2003307733

(51) Int. Cl. H01M 4/62; B02B 5/02

(52) U.S. Cl. 429/232; 252/182.1; 429/217; 241/25

(57) ABSTRACT

Composite particles for an electrode of the invention are produced through a granulating step in which, a conductive additive and a binder are brought into a close contact with particles consisting of the electrode active material to integrate with each other. The granulating step preferably comprises a process for preparing a stock solution comprising the binder, the conductive additive and a solvent, a process for forming a fluidized bed by throwing particles of electrode active material into a fluidizing bathe and a process for bringing the particles of electrode active material and the particles of conductive additive into a close contact with the binder by spraying a stock solution into the fluidizing bathe, allowing the stock solution adhering to the particles of electrode active material and drying the same to remove the solvent from the adhered stock solution. Composite particles thus obtained are used as the constituent material for electrode, and further, the electrode is used as an anode and/or cathode of an electrochemical element; thereby, the internal resistance of electrode can be reduced satisfactorily and the power density of the electrochemical element can be increased satisfactorily.

### TECHNICAL FIELD

The present invention relates to a composite particle for electrode, which is used as constituent material for electrode usable for an electrochemical element such as a primary cell, a secondary cell (particularly, lithium ion secondary cell), an electrolytic cell, a capacitor (particularly, electrochemical capacitor) and producing method thereof. Also, the invention relates to an electrode in which the composite particle for electrode is used as a constituent material and the producing method thereof and an electrochemical element provided with the electrode and producing method thereof.

### BACKGROUND ART

Recently, potable equipments have been developed brilliantly. As a large driving force, development of a high-energy cell such as a lithium ion secondary cell, which are widely employed as a power source for such equipments are given. Such high-energy cell comprises, principally, a cathode, an anode and an electrolyte layer (for example, a layer consisting of liquid electrolyte or solid electrolyte) disposed between the cathode and the anode.

Electrochemical elements such as the high-energy batteries exemplified by the lithium ion secondary cell and electrochemical capacitors exemplified by electric double layer capacitor are now under various research and development for further increasing the characteristics to respond to the future development of equipments such as potable equipments in which electrochemical elements are provided. Particularly, it is desired to further improve the power density. And further, it is desired to achieve an electrochemical element having superior charging/discharging characteristics capable of satisfactorily responding to sharp and, in particular, large changes of the load requirements of the equipment.

Conventionally, the cathode and/or anode are produced through the following process; i.e., a coating liquid (for example, one in slurry state or paste state) for forming an electrode, which comprises an electrode active material, a binder (synthetic resin or the like), a conductive additive and a dispersion medium and/or a solvent, is prepared; and the coating liquid is applied to the surface of a collector (for example, metallic foil or the like), and then dried; thereby a layer comprising the electrode active material (referred to as an “active material-containing layer”) is formed on the surface of the collector (for example, refer to Japanese Patent Application Laid-Open No. Hei 11-283615).

In this method (wet processing), the conductive additive may not be added to the coating liquid. In place of the coating liquid, without using the dispersion medium and solvent, sometimes a kneaded product comprising an electrode active material, a binder and a conductive additive is prepared, and the product may be formed into a sheet-like configuration using a heat roll pressing machine and/or a heat pressing machine. Also, the coating liquid may be further added with conductive polymer to form, so-called, “polymer electrode.” In the case where the electrolyte layer is solid, a method, in which the coating liquid is applied to the surface of the electrolyte layer, may be employed.

Further, in order to further improve the cell characteristics, for example, the following positive electrode for lithium secondary cell and producing method thereof has been proposed. That is, a composite particle comprising a manganese dioxide (active material for cathode) particle and carbon material powder fixed to the surface of the manganese dioxide particle (conductive additive) is used as the electrode material for the cathode to prevent the charging/discharging capacity of cell from being reduced, which is caused from the cathode (for example, refer to Japanese Patent Application Laid-Open No. Hei 2-262243).

Furthermore, in order to further increase the discharging characteristic and productivity or the like, the producing method of a positive electrode mix for an organic electrolyte cell has been proposed. That is, slurry comprising a positive electrode active material (active material for cathode), a conductive agent (conductive additive), a binder and a solvent, of which solid content is 20 to 50% by weight; and average particle diameter of the solid content is 10 μm or less, is prepared, and the slurry is granulated in a manner of spray drying method (for example, refer to Japanese Patent Application Laid-Open No. 2000-40504).

### DISCLOSURE OF THE INVENTION

However, the lithium ion secondary cell equipped with an electrode, which was produced in a manner of wet processing of the art disclosed, for example, in the above-described Japanese Patent Application Laid-Open No. Hei 11-283615, had the following problem. There is a limit to increase the power density of the cell; and particularly, when the cell was used under operation conditions such that the load requirements changes sharply and, in particular, largely, it was extremely difficult to form a cell, which had superior charging/discharging characteristics capable of satisfactorily responding to such load requirements.

That is, to further increase the output of the cell, when the thickness of the active material-containing layer for electrode is made thinner, since the internal resistance (impedance) of the entire active material-containing layer can be reduced, it is possible to achieve the above intension. However, in this case, the content of the active material is short, and accordingly, the cell capacity and the energy density of the cell is hardly ensured satisfactorily. Since the collector and the separator do not contribute to the cell capacity, from this viewpoint also, the cell capacity is hardly ensured satisfactorily.

Further, the inventors found the following fact. That is, the composite particle disclosed in Japanese Patent Application Laid-Open No. Hei 2-262243 is insufficient in mechanical strength. Therefore, carbon material powder fixed to the surface of the manganese dioxide particle peels off easily during forming of the electrode. Satisfactory dispersion of the carbon material powder within the obtained electrode tends to be insufficient. Therefore, the desired improvement of the electrode characteristics and further increase of the output of cell are hardly obtained reliably or satisfactorily.

Further, a positive electrode mix for an organic electrolyte cell disclosed in Japanese Patent Application Laid-Open No. 2000-40504 is produced in the following manner. That is, slurry containing a solvent is sprayed and dried in a hot air to form cluster (composite particles) comprising a positive electrode active material, a conductive agent and a binder. Here, the inventors found the following fact. That is, in this case, the process of dry and solidification advances in a state that the positive electrode active material, the conductive agent and the binder are dispersed in a solvent. Therefore, since agglomeration of the binder itself and agglomeration of the conductive agent advance during the drying process, and the conductive agent and the binder failed in establishing a close contact with the surface of each particle consisting of the positive electrode active material constituting the obtained cluster (composite particles) in a state that an effective conductive network is established respectively being dispersed satisfactorily. Therefore, it is difficult to further increase the output of the cell reliably and satisfactorily.

In particular, the inventors found the following fact; i.e., in the art disclosed in Japanese Patent Application Laid-Open No. 2000-40504, as shown in FIG. 22, among the respective particles consisting of positive electrode active material constituting obtained cluster (composite particles) P100, there are many clusters P11, which are enclosed only by a large agglomerate P33 of binder, being electrically isolated, and accordingly, not being utilized, in the clusters (composite particles) P100. Also, the inventors found the following fact. That is, when particles consisting of the conductive agent form an agglomerate during drying process, the particles consisting of the conductive agent are unevenly distributed into an agglomerate P22 within the obtained cluster (composite particles) P100. Thus conduction paths for the electron (electron conduction network) are not established satisfactorily in the cluster (composite particles) P100. Therefore, the electron conductivity cannot be obtained satisfactorily. Further, the inventors found the following fact. That is, the large agglomerate P33 consisting of a binder only encloses the agglomerate P22 of particles consisting of the conductive agent while electrically isolating the particles. In this viewpoint also, conduction path for the electron (electron conduction network) is not established satisfactory in the cluster (composite particles) P100 failing in obtaining the electron conductivity satisfactorily.

Further, the inventors found the following fact. That is, in the conventional electrodes such as composite particles disclosed in the above-described Japanese Patent Application Laid-Open No. Hei 2-262243 and Japanese Patent Application Laid-Open No. 2000-40504, in order to ensure the stability of configuration of the electrode, a large amount of binder (binder), of which insulation performance or electron conductivity is low, is used along with the electrode active material and the conductive additive. Therefore, in this viewpoint also, the electron conductivity of the electrode is not ensured satisfactorily. Also, in the case where the electrode is produced using the composite particles disclosed in the above-described Japanese Patent Application Laid-Open No. Hei 2-262243 and Japanese Patent Application Laid-Open No. 2000-40504, since the binder is used, the above-described problems occur.

In a primary cell and a secondary cell also, which are another type of the above-described lithium ion secondary cell, in the case of the cell, which has the electrode produced in the above-described conventional ordinary producing method (wet processing), i.e., a method, which uses the coating liquid comprising at least the electrode active material, the conductive additive and the binder, there resides the same problem as described above.

Further, in an electrolytic cell and capacitor (for example, an electrochemical capacitor such as an electric double layer capacitor) having the electrode produced in a method, which uses, in place of the electrode active material in the cell, an electron conductive material (carbon material or metal oxide) as the electrode active material and slurry comprising at least the conductive additive and the binder, there resides the same problem as described above.

The invention has been proposed in view of the problems residing in the above-described conventional arts. An object of the invention is to provide a composite particle for electrode, which is, even when the binder is used as the constituent material of electrode, capable of easily and reliably forming the electrode having superior electrode characteristics. Another object of the invention is to provide an electrode, which comprises the composite particle for electrode as the constituent material of which internal resistance is satisfactorily reduced, and has superior electrode characteristics capable of easily increasing the power density of the electrochemical element satisfactorily, as well as, to provide an electrochemical element, which is provided with such electrode and has superior charging and discharging characteristics capable of, even when the load requirements change sharply and, in particular, largely, responding thereto satisfactorily. Further another object of the invention is to provide a producing method for easily and reliably obtaining the above-described composite particle for electrode, electrode and electrochemical element respectively.

The inventors intensively studied to achieve the above objects. As a result, the following fact was found. That is, to form an electrode, the conventional electrode forming method employs a method which uses a coating liquid or a kneaded product comprising at least the above-described electrode active material, conductive additive and binder. Therefore, the electrode active material, conductive additive and binder in the active material-containing layer of the obtained electrode are dispersed unevenly. This fact largely affects to cause the above-described problems.

That is, in the conventional methods, in which a coating liquid or a kneaded product is used like the arts disclosed in Japanese Patent Application Laid-Open No. Hei 11-283615 and Japanese Patent Application Laid-Open No. Hei 2-262243, a coating liquid or a kneaded product is applied to the surface of the collector to form a coating of the coating liquid or the kneaded product on the surface, and then the coating is dried to remove the solvent; thereby the active material-containing layer is formed. The inventors found the following fact. That is, in the drying process of the coating, the conductive additive and binder with small specific gravity float up to the adjacent of the coating surface. As a result, the following state was found. That is, a state of dispersion of the electrode active material, the conductive additive and binder in the coating failed to establish an effective conductive network; for example, the state of dispersion was uneven; close contact among the electrode active material, conductive additive and binder was not satisfactorily established; and in the obtained active material-containing layer, the conduction path for the electron was not established satisfactorily; accordingly, the resistivity and the charge transfer overvoltage of the active material-containing layer was not reduced satisfactorily.

Further, the following fact was found. That is, in the conventional method for granulating slurry into the composite particle by means of spray drying as disclosed, for example, in Japanese Patent Application Laid-Open No. 2000-40504, a positive electrode active material (active material for cathode), a conductive agent (conductive additive) and a binder are comprised in the same slurry. In this case, the state of dispersion of the electrode active material, the conductive additive and the binder in the obtained granulated matter (composite particles) depends on the state of dispersion of the electrode active material, the conductive additive and the binder in the slurry (particularly, the state of dispersion of the electrode active material, the conductive additive and the binder during the process that drop of the slurry is dried). Therefore, as previously described referring to FIG. 22, agglomeration and uneven distribution of the binder, and agglomeration and uneven distribution of the conductive additive occur. As a result, the following state is resulted in. That is, an effective conductive network is not established among the dispersed electrode active material, the conductive additive and the binder in the obtained granulated matter (composite particles). For example, due to uneven dispersion of the electrode active material, the conductive additive and the binder, the close contact among these is not satisfactorily established; thus, the electron conduction path is not satisfactorily established in the obtained active material-containing layer.

Further, the inventors found the following fact. That is, in the above case, the conductive additive and the binder can not be selectively and satisfactorily dispersed on the surface of the electrode active material, which can come into contact with the electrolyte and participate in the reaction of the electrode. And, there reside such useless conductive additives that do not contribute to establishing electron conduction network for effectively conducting the electron generated in the reaction field: and there reside such useless binders that contribute to just increasing the electric resistance.

Further, the inventors found the following fact. That is, in such conventional art as composite particles disclosed in Japanese Patent Application Laid-Open No. Hei 2-262243 and Japanese Patent Application Laid-Open No. 2000-40504, since the state of dispersion of the electrode active material, the conductive additive and the binder in the coating is uneven, the close contact of the electrode active material and the conductive additive with the collector was not established satisfactorily. Particularly, such problem that the state of dispersion of the electrode active material, the conductive additive and the binder in the coating and the electrode obtained thereby is uneven, and the problem that these components are distributed unevenly in the electrode respectively appears considerably when the thickness of the electrode is increased.

It is generally understood among the persons skilled in the art that, when the binder is used, the internal resistance of the electrode tends to increase. However, the inventors found the following fact and achieved the present invention. That is, when a particle comprising the electrode active material, the conductive additive and the binder is previously formed by means of granulating step, which will be described below, and when the active material-containing layer for electrode is formed using the particle as the constituent material, even when the binder is comprised therein, an active material-containing layer, which has the resistivity value (or, internal resistance value after being normalized with superficial volume) satisfactorily lower than that of the electrode active material itself, can be formed.

That is, the invention provides a composite particle for electrode comprising an electrode active material, a conductive additive having electron conductivity and a binder capable of binding the electrode active material and the conductive additive, the composite particle for electrode being formed through a granulating step in which the conductive additive and the binder are brought into a close contact with the particle consisting of the electrode active material and integrated with each other, and the granulating step comprising:

a stock solution preparing step for preparing a stock solution comprising the binder, the conductive additive and a solvent;

a fluidized bed forming step for forming the particle consisting of the electrode active material into a fluidized bed by throwing the particle consisting of the electrode active material into a fluidizing bathe; and

a spray-drying step, in which the stock solution is sprayed into the fluidized bed comprising the particle consisting of the electrode active material, thereby the stock solution is allowed adhering to the particle consisting of the electrode active material and dried to remove the solvent from the stock solution adhered to the surface of the particle consisting of the electrode active material to bring the particle consisting of the electrode active material and the particle consisting of the conductive additive into a close contact with each other by means of the binder.

In this invention, the wording “electrode active material”, which serves as the constituent material of the composite particle for electrode, means the following substances depending on the electrode to be formed. That is, in the case of an electrode where the electrode to be formed is used as the anode of a primary cell, the wording “electrode active material” means a reducing agent; and in the case of a cathode of a primary cell, the wording “electrode active material” means an oxidizing agent. In the “particle consisting of the electrode active material”, a substance other than the electrode active material may be comprised to an extent that the function of the invention (function of the electrode active material) is not reduced.

Further, in the case where the electrode to be formed is an anode, which is used in a secondary cell (at discharging), the wording “electrode active material” means a reducing agent, which is a substance capable of existing chemically stably in any of reductant state and oxidant state; and capable of acting reversibly in any of the reductive reaction from an oxidant to a reductant, and the oxidative reaction from the reductant to the oxidant. Further, in the case where the electrode to be formed is a cathode (at discharging), which is used in a secondary cell, the wording “electrode active material” means an oxidizing agent, which is a substance capable of, in any state of reductant and oxidant, existing chemically stably; and capable of reversibly acting any of reductive reaction from oxidant to reductant and oxidative reaction from reductant to oxidant.

Also, in addition to the above, in the case where the electrode to be formed is an electrode, which is used in a primary cell and a secondary cell, the “electrode active material” may be a material capable of storing or releasing a metal ion, which participates in the electrode reaction (intercalate, or doping/dedoping). As for this material, for example, a carbon material, a metal oxide (comprising a composite metal oxide) or the like, which are used for the anode and/or cathode of a lithium ion secondary cell, are mentioned.

In this description, as a matter of convenience, the electrode active material for the anode will be referred to as an “anode active material”; and the electrode active material for the cathode will be referred to as a “cathode active material.” In this case, the wording “anode” in the expression of “anode active material” will be used on the basis of the polarity when the cell is discharged (negative electrode active material); and the wording “cathode” in the expression of “cathode active material” will be used on the basis of the polarity when the cell is discharged (positive electrode active material). Particular examples of the anode active material and the cathode active material will be given later.

Also, in the case where the electrode to be formed is an electrode used for an electrolytic cell or an electrode used for a capacitor (condenser), the wording “electrode active material” means a metal (comprising metal alloy), a metal oxide or a carbon material having the electron conductivity.

In the above-described granulating step, a fine drop of the stock solution, which comprises the conductive additive and the binder, is sprayed directly to the particle consisting of the electrode active material in the fluidizing bathe. Therefore, compared to the case of the above-described conventional forming methods of the composite particle, the respective constituent particles constituting the composite particle can be satisfactorily prevented from advance of agglomeration. As a result, the respective constituent particles in the obtained composite particles can be satisfactorily prevented from being unevenly distributed. Further, the conductive additive and the binder can be selectively and satisfactorily dispersed on the surface of the electrode active material, which can come into contact with the electrolyte and participate in the reaction of the electrode.

Therefore, the composite particles for electrode in accordance with the invention are brought into a close contact with each other, in a state in which each of these has been extremely satisfactorily dispersed. Also, in the composite particle for electrode in accordance with the invention, the particle size thereof can be controlled, by controlling the temperature in the fluidizing bathe, the spray amount of the stock solution to be sprayed into the fluidized bed, the amount of electrode active material to be thrown into the airflow generated in the fluidizing bathe, the speed of the airflow generated in the fluidizing bathe, the type of the flow (circulation) of the airflow (laminar flow, turbulent flow etc) or the like in the granulating step. The composite particle for electrode is used as the constituent material of a coating liquid or a kneaded product for producing the electrode.

Thus, in the above-described granulating step, the drop of raw material comprising the conductive additive and the like is directly sprayed to the flown particles. Therefore, the flowing method of the particle is not particularly limited. For example, a fluidizing bathe in which airflow is generate and the particle is flown by the airflow, a fluidizing bathe in which the particle is rotated and flown by a stirring blade, a fluidizing bathe in which the particle is flown by means of the vibration or the like may be employed. In the producing method of the composite particle for electrode, in order to evenly form the configuration and size of the obtained composite particle, it is preferred that, in the fluidized bed forming step, the airflow is generated in the fluidizing bathe, the particle consisting of the electrode active material is thrown into the airflow and the particle consisting of the electrode active material is formed into a fluidized bed.

Within the composite particle for electrode, the electron conduction path (electron conduction network) is established extremely satisfactorily in three dimensionally. In the structure of the electron conduction path, even after the coating liquid or the kneaded product which comprises the particle is prepared, by controlling the preparing conditions (for example, selection of the dispersion medium or the solvent, or the like when preparing the coating liquid), substantially initial state thereof can be easily maintained.

Therefore, in the process, in which the liquid film of coating liquid or the kneaded product comprising the composite particle for electrode is formed on the surface of collector member, and then, the liquid film is solidified (a process, for example, drying the liquid film or the like), unlike the conventional method, the close contact among the conductive additive, the electrode active material and the binder can be satisfactorily prevented from reducing, and the close contact of the conductive additive and the electrode active material with the surface of collector member can be satisfactorily prevented from reducing.

The inventors understand the reason of the above as described below. That is, in the active material-containing layer for electrode obtained in accordance with the invention, compared to the conventional electrodes, the electron conduction path (electron conduction network) is established extremely satisfactorily in three-dimension.

Further, even when the active material-containing layer for electrode is formed relatively thick (for example, 150 μm or more), by using the composite particle for electrode in accordance with the invention, the electrode characteristics superior to the conventional can be obtained. That is, the energy density per capacity of the electrochemical element such as cell can be increased easily and reliably. Further, even when the active material-containing layer for electrode is formed comparatively thin (for example, 100 μm or less), since an electrode with low internal resistance can be formed by using the composite particle for electrode in accordance with the invention, which has superior electron conductivity, the electrochemical element equipped with the electrode enables the charging and discharging (when the electrochemical element is a primary cell, discharge only) swift and satisfactory repeatability at a current density comparatively higher than the conventional electrodes (for example, when the thickness of the active material-containing layer is 100 μm, 3 mA/cm² or more).

Extremely satisfactory ion conduction path can be established easily in the active material-containing layer for electrode also by carrying out any one of the following techniques. That is, (A) when producing the composite particle for electrode, a conductive polymer, which has the ion conductivity, is further added as the constituent material; (B) when preparing a coating liquid or a kneaded product for forming an electrode, a conductive polymer having the ion conductivity is added as the constituent other than the composite particle for electrode; and (C) a conductive polymer having the ion conductivity is added to both of the composite particle for electrode as the constituent material thereof, and a coating liquid or kneaded product for forming electrode as the constituent thereof.

When a conductive polymer having the ion conductivity can be used as the binder to be the constituent material of the composite particle for electrode, the conductive polymer having the ion conductivity may be used. It is understood that the binder having the ion conductivity also contributes to establishing the ion conduction path in the active material-containing layer. By using the composite particle for electrode, the above-described polymer electrode can be formed. Further, as the binder, which will be the constituent material of the composite particle for electrode, a polymer electrolyte having the electron conductivity may be used.

By employing the above-described constitution, in this invention, the electrode, which has the electron conductivity and the ion conductivity superior to the conventional electrodes, can be formed easily and reliably. In the electrode formed using the composite particle for electrode in accordance with the invention, the contact boundary among the conductive additive, the electrode active material and the electrolyte (solid electrolyte or liquid electrolyte), which serves as the reaction field of the charge transfer reaction advancing in the active material-containing layer, is formed three dimensionally in a satisfactory size; and also, the electrical contact state between the active material-containing layer and the collector member is in an extremely satisfactory state.

Further, according to the invention, the composite particle for electrode in a state extremely satisfactory dispersion of each of the conductive additive, the electrode active material and the binder is previously formed. Therefore, the addition amount of the conductive additive and the binder can be more satisfactorily reduced than the conventional particles.

In the invention, when a conductive polymer is used, the conductive polymer may be of the kind same as or different from the conductive polymers which serve as the constituent element of the above-described composite particle for electrode.

Further, in the invention, the electrode active material may be an active material which can be used for the cathode of a primary cell or a secondary cell. Also, in the invention, the electrode active material may be an active material which can be used for the anode of the primary cell or the secondary cell. Further, in the invention, the electrode active material may be a carbon material or a metal oxide which has the electron conductivity usable for the electrode constituting the electrolytic cell or capacitor. In the invention, the electrolytic cell or capacitor represents an electrolytic cell that is provided with at least a first electrode (anode), a second electrode (cathode) and an electrolyte layer having the ion conductivity, and an electrochemical cell, of which the first electrode (anode) and second electrode (cathode) are disposed opposite to each other being interposed by the electrolyte layer. In this description, the wording “capacitor” is the identical to the wording “condenser.”

By providing the electrode comprising the composite particle for electrode to at least either one of the anode or cathode, preferably to both thereof, an electrochemical element, which is capable of obtaining superior charging/discharging characteristics, can be structured easily and reliably.

Further, the invention provides an electrode comprising at least a conductive active material-containing layer comprising, as the structural material, composite particles composed of an electrode active material, a conductive additive having electron conductivity, and a binder capable of binding the electrode active material and the conductive additive, and a current collector situated in electrical contact with the active material-containing layer,

the composite particle being formed through a granulating step in which the conductive additive and the binder are brought into a close contact with the particle consisting of the electrode active material and integrated with each other, and

the electrode active material and the conductive additive being non-isolated and electrically linked with each other in the active material-containing layer.

Compared to the conventional electrodes, in the electrode in accordance with the invention, the resistivity and the charge transfer overvoltage of the active material-containing layer are satisfactorily reduced. Therefore, the power density of the electrochemical element can be satisfactorily increased easily and reliably.

The composite particle used for the electrode in accordance with the invention is a particle, in which the conductive additive, the electrode active material and the binder are brought into a close contact with each other, in a state in which each of these has been extremely satisfactorily dispersed. The composite particle is used as main component of fine particles for producing the active material-containing layer for electrode by means of the dry method, which will be described later; or used as the constituent material of the coating liquid or kneaded product for producing the active material-containing layer for electrode by means of the wet processing, which will be described later.

In the composite particle, an extremely satisfactory electron conduction path (electron conduction network) is established three-dimensionally. When used as the main component of fine particles for producing the active material-containing layer for electrode by means of the dry method, which will be described later, even after forming the active material-containing layer by means of the heat treatment, the structure of the electron conduction path can be maintained in substantially initial state. Also, when used as the constituent material of the coating liquid or kneaded product for producing the active material-containing layer for electrode by means of the wet processing, which will be described later, even after preparing the coating liquid or kneaded product comprising the composite particle, by controlling the preparing conditions (for example, selection of a dispersion medium or solvent for preparing the coating liquid, or the like), the structure of the electron conduction path can be easily maintained in substantially initial state.

That is, the electrode in accordance with the invention is formed in a state in which the above-described structure of the composite particle is maintained. Therefore, in the active material-containing layer, the electrode active material and the conductive additive are electrically bound to each other without being isolated from each other. Therefore, in the active material-containing layer, an extremely satisfactory electron conduction path (electron conduction network) is established three-dimensionally. Here, the wording “in the active material-containing layer, the electrode active material and the conductive additive are electrically bound to each other without being isolated from each other” means the state that, in the active material-containing layer, the particle consisting of the electrode active material (or agglomerate thereof) and the particle consisting of the conductive additive (or agglomerate thereof) are electrically bound to each other “substantially” without being isolated from each other. In particular, it does not mean such a sate that all of the particles consisting of the electrode active material (or agglomerate thereof) and the particle consisting of the conductive additive are electrically bound to each other without utterly isolated from each other, but means such a state that the both are electrically satisfactorily bound to each other in a range that the electric resistance of a level in which the effect of this invention can be obtained.

The state of “in the active material-containing layer, the electrode active material and the conductive additive are bound electrically to each other without being isolated from each other” can be confirmed by means of an SEM (Scanning Electron Micro Scope) photograph, TEM (Transmission Electron Microscope) photograph and EDX (Energy Dispersive X-ray Fluorescence Spectrometer) analysis data of sections of the active material-containing layer for electrode in accordance with the invention. Also, by comparing SEM photograph, TEM photograph and EDX analysis data of sections of the active material-containing layer to SEM photograph, TEM photograph and EDX analysis data of the conventional electrodes, the electrode in accordance with the invention can be apparently distinguished from the conventional electrodes.

In the electrode in accordance with the invention, the granulating step preferably comprises:

a stock solution preparing step for preparing a stock solution comprising the binder, the conductive additive and a solvent;

a fluidized bed forming step for forming the particle consisting of the electrode active material into a fluidized bed by throwing the particle consisting of the electrode active material into a fluidizing bathe; and

a spray-drying step, in which the stock solution is sprayed into the fluidized bed comprising the particle consisting of the electrode active material, thereby the stock solution is allowed adhering to the particle consisting of the electrode active material and dried to remove the solvent from the stock solution adhered to the surface of the particle consisting of the electrode active material to bring the particle consisting of the electrode active material and the particle consisting of the conductive additive into a close contact with each other by means of the binder.

By employing the granulating step arranged as described above, the above-described composite particle can be produced more reliably, and as a result, the effect of the invention can be obtained more reliably. In this granulating step, within the fluidizing bathe, fine drop of the stock solution comprising the conductive additive and the binder is directly sprayed to the particle consisting of the electrode active material. Therefore, compared to the above-described conventional producing method of the composite particles, the agglomeration of the respective constituent particles constituting the composite particle can be satisfactorily prevented from advancing. As a result, each of the constituent particles in the obtained composite particle can be satisfactorily prevented from being unevenly distributed. Further, the conductive additive and the binder are allowed dispersing selectively and satisfactorily to the surface of the electrode active material which can be brought into contact with the electrolyte and participate in the electrode reaction.

Accordingly, the obtained composite particle becomes such particles that the conductive additive, the electrode active material and the binder are brought into a close contact with each other, in a state in which each of these has been extremely satisfactorily dispersed. Further, the particle size of the composite particle can be controlled by, in the granulating step, controlling the temperature in the fluidizing bathe, the amount of the stock solution to be sprayed in the fluidizing bathe, the amount of the electrode active material thrown into the airflow generated within the fluidizing bathe, the speed of the airflow generated within the fluidizing bathe and, type of the flow (circulation) of the airflow (laminar flow, turbulent flow etc) or the like.

In the composite particle produced in the granulating step as described above, an extremely satisfactory electron conduction path (electron conduction network) is established three-dimensionally and more reliably. And in this case also, when used as the main component of fine particles for producing the active material-containing layer for electrode by means of the dry method, which will be described later, even after forming the active material-containing layer by means of the heat treatment, the structure of the electron conduction path can be maintained in substantially initial state. Also, when used as the constituent material of the coating liquid or kneaded product for producing the active material-containing layer for electrode by means of the wet processing, which will be described later, even after preparing the coating liquid or kneaded product comprising the composite particle, by controlling the preparing conditions (for example, selection of a dispersion medium or a solvent for preparing the coating liquid, or the like), the structure of the electron conduction path can be easily maintained in substantially initial state.

Therefore, when the composite particle is used as the main component of fine particles for producing the active material-containing layer for electrode by means of the dry method, which will be described later, unlike the conventional conductive additive, the close contact between the electrode active material and the binder and the close contact of the conductive additive and the electrode active material with the surface of the collector can be satisfactorily prevented from decreasing.

Also, when the active material-containing layer for electrode is formed by means of wet processing, which will be described later, in the process in which the liquid film of coating liquid or kneaded product comprising the composite particle is formed on the surface of the collector, and then, the liquid film is solidified (for example, process to dry the liquid film, etc), unlike the conventional methods, the close contact among the conductive additive, the electrode active material and the binder and the close contact of the conductive additive and the electrode active material with the surface of the collector can be satisfactorily prevented from decreasing.

The inventors understand the reason of the above. That is, as a result of the above, in the active material-containing layer for electrode in accordance with the invention, compared to the conventional electrode, an extremely satisfactory electron conduction path (electron conduction network) is established three-dimensionally, the resistivity and the charge transfer overvoltage of the active material-containing layer can be largely reduced.

Further, even when the active material-containing layer for electrode is formed comparatively thinly (for example, 100 μm or less), by using the above-described composite particles having superior electron conductivity, an electrode of which internal resistance (impedance) is low can be formed. The electrochemical element provided with this electrode can charge and discharge (when the electrochemical element is a primary cell, discharge only) with swift and satisfactory repeatability at a current density comparatively higher than the conventional (for example, when the thickness of the active material-containing layer is 100 μm, 3 mA/cm² or more). Thus, a higher output can be achieved easily.

In this case, in order to reliably increase the output of the electrochemical element, the thickness T of the active material-containing layer and average particle diameter d of composite particles comprised in the active material-containing layer preferably satisfy the conditions expressed by following formulas (1) to (3):
0.0005≦(T/d)≦1 (1)
1 μm≦T≦150 μm (2)
1 μm≦d≦2000 μm (3).

If the conditions of the formulas (1) to (3) are not satisfied simultaneously, the following tendency appears largely. That is, when (T/d) in the formula (1) is smaller than 0.0005, the following tendency largely appears. That is, the pressure for extending the layer of the composite particle sprayed (disposed) on the collector to form the active material-containing layer by applying pressure becomes higher. The above-described satisfactory electron conduction network in the composite particle is hardly maintained.

When (T/d) of the formula (1) exceeds 1, the following tendency appears largely. That is, in the active material-containing layer, a state in which plural composite particles are piled up in line in the direction of the normal line of the collector is formed. The contact boundary is formed between the composite particles. Since the boundary resistance (electric resistance) between the composite particles is larger than the internal resistance in the composite particle, satisfactory output characteristics are hardly obtained.

Further, when T in the formula (2) is smaller than 1 μm, the following tendency appears largely. That is, since mechanical strength of the active material-containing layer is not satisfactory, satisfactory handling performance is hardly obtained. Further, when T in the formula (2) exceeds 150 μm, the following tendency appears largely. That is, the distance between the upper portion of the active material-containing layer (adjacent portion of the surface opposite to the surface which contact with the collector) and the collector becomes too large resulting in a longer charge transfer path. Thus, satisfactory output characteristics are hardly obtained.

Further, when d in the formula (3) is smaller than 1 μm, the following tendency appears largely. That is, particles (particles consisting of the electrode active material, etc), which serve as the core for producing the composite particle, become too small; thus the satisfactory compounds are hardly produced. When the granulating step is carried out using the fluidizing bathe as described above, the following tendency appears largely. That is, particles to be cores within the fluidizing bathe agglutinate; and thus, stable fluidized bed is hardly formed. Further, when d in the formula (3) exceeds 2 mm, for the particles to be cores for producing the composite particle, particles with a large particle diameter have to be used. In this case, since the ion diffusion speed within the particles with a large particle diameter is large, such tendency appears largely; i.e., satisfactory output characteristics are hardly obtained.

The electrode in accordance with the invention may be characterized in that a conductive polymer is further comprised in the active material-containing layer. Owing to this, the above-described polymer electrode can be formed. In this case, the conductive polymer may be characterized by being a conductive polymer having the ion conductivity, or being a conductive polymer having the electron conductivity. Also, as the conductive polymer, a conductive polymer having the ion conductivity and a conductive polymer having the electron conductivity may be used simultaneously.

By adapting as described above, in accordance with the invention, the electrode, which has the electron conductivity and the ion conductivity superior to the conventional electrodes, can be formed easily and reliably. When the composite particle is used as the main component of fine particles for forming the active material-containing layer for electrode by means of the dry method, which will be described later, the conductive polymer can be comprised in the active material-containing layer by adding as the constituent other than the composite particle into the fine particles. Also, when preparing the coating liquid for forming an electrode or the kneaded product for forming electrode, a conductive polymer can be comprised in the active material-containing layer by adding the conductive polymer as the constituent other than the composite particle.

Further, in the electrode in accordance with the invention, when forming the composite particle, a conductive polymer may be further added as the constituent material. That is, the composite particle may be characterized in that a conductive polymer is further comprised. In this case also, the conductive polymer may be characterized by being a conductive polymer having the ion conductivity, or being a conductive polymer having the electron conductivity. Also, as the conductive polymer, a conductive polymer having the ion conductivity and a conductive polymer having the electron conductivity may be used simultaneously.

As described above, by forming the active material-containing layer using the composite particle comprising the conductive polymer, an extremely satisfactory ion conduction path and/or electron conduction path can be established easily in the active material-containing layer for electrode. The conductive polymer may be comprised in the composite particle by adding further as the constituent material when forming the composite particle.

In the electrode in accordance with the invention, when a conductive polymer can be used as the binder, which serves as the constituent material of the composite particle, the conductive polymer having the ion conductivity may be used. That is, the invention may be characterized in that the binder consists of a conductive polymer. It is understood that the binder having the ion conductivity contributes to establishing an ion conduction path in the active material-containing layer; and the binder having the electron conductivity contributes to establishing an electron conduction path in the active material-containing layer.

The conductive polymer may be added to any of the followings; i.e., the constituent material of the composite particle, the constituent of the fine particles (dry method) for forming electrode, the constituent of the coating liquid for forming an electrode (wet processing) and the constituent of kneaded product (wet processing) for forming electrode. In this case also, an extremely satisfactory ion conduction path can be established easily in the active material-containing layer for electrode.

In the electrode formed using the composite particle, contact boundary among the conductive additive, the electrode active material and the electrolyte (solid electrolyte or liquid electrolyte), which serves as the reaction field of the electron transfer reaction advancing within the active material-containing layer, is formed three-dimensionally in a satisfactory size. The state of electrical contact between the active material-containing layer and the collector is also in an extremely satisfactory state.

Further, in the invention, the composite particle, of which state of dispersion of the conductive additive, the electrode active material and the binder is extremely satisfactory respectively, is previously formed. Therefore, compared to the conventional composite particles, the amount of the conductive additive and the binder to be added can be satisfactorily reduced.

In the electrode in accordance with the invention, when a conductive polymer is used, the conductive polymer may be of the type same as or different from the conductive polymers which serve as the constituent element of the above-described composite particles.

Further, in the electrode in accordance with the invention, the electrode active material may be an active material, which can be used for the cathode of the primary cell or the secondary cell. In this invention, the electrode active material may be an active material, which can be used for the anode of the primary cell or the secondary cell. Further, in the invention, the electrode active material may be a carbon material or metal oxide having the electron conductivity, which is usable for the electrode constituting the electrolytic cell or the capacitor.

The invention provides an electrochemical element comprising at least an anode, a cathode and an electrolyte layer having the ion conductivity, the element having a structure such that the anode and the cathode are disposed opposite to each other being interposed by an electrolyte layer,

any one of the electrode of the above-described inventions being provided as the electrode of one or both of the anode and the cathode.

By providing the electrode in accordance with the invention provided with the active material-containing layer comprising the composite particle to at least one or preferably both of the anode and the cathode, the electrochemical element, which has superior charging/discharging characteristics capable, even when the load requirements change sharply and largely, of responding thereto satisfactorily, can be structured easily and reliably.

Here, in this invention, the wording “electrochemical element” means an element, which has at least a first electrode (anode) and a second electrode (cathode) opposing to each other, and which has a structure such that, at least an electrolyte layer having the ion conductivity is provided disposed between these first electrode and the second electrode. Also, the wording “electrolyte layer having the ion conductivity” means the followings; i.e., (i) a porous separator formed of insulative material, in which an electrolyte solution (or gel electrolyte obtained by adding a gelatinizing agent to an electrolyte solution) is impregnated; (ii) a solid electrolyte film (a film consisting of a solid polymer electrolyte, or a film comprising an ion conductive inorganic material), (iii) a layer consisting of a gel electrolyte obtained by adding a gelatinizing agent to the electrolyte solution, and (iv) a layer consisting of an electrolyte solution.

Any case of the above structure of (i) to (iv) may have such structure that the electrolyte to be used for each of these is comprised in the first electrode and second electrode.

In this description, in the structures of (i) to (iii), the laminated item formed of the first electrode (anode), the electrolyte layer, and the second electrode (cathode) will be occasionally referred to as “element.” Further, as for the element, in addition to the 3-layered structure like the above structures of (i) to (iii), a structure of 5-layer or more in which the electrode and the electrolyte layer are built up alternately may be employed.

In any of structures of (i) to (iv), the electrochemical element may have a module structure such that plural unit cells are disposed in series or in parallel in one case.

The electrochemical element in accordance with the invention may be characterized in that the electrolyte layer consists of a solid electrolyte. In this case, the solid electrolyte may be characterized by consisting of a ceramics solid electrolyte, a solid polymer electrolyte, or a gel electrolyte obtained by adding a gelatinizing agent to a liquid electrolyte.

In this case, an electrochemical element, in which all of the constituent elements are of solid (for example, so called “all solid-type cell”), can be structured. Owing to this, the weight of the electrochemical element can be reduced, and the energy density can be increased as well as the safety level can be increased more easily.

As the electrochemical element, when a “all solid-type cell” is structured (particularly, a all solid-type lithium ion secondary cell is structured), the following advantages of (I) to (IV) are obtained. That is, (I) since the electrolyte layer does not consist of a liquid electrolyte but of a solid electrolyte, no liquid leaks, a superior heat resistance (high temperature stability) can be obtained, and the reaction between the electrolyte component and the electrode active material can be satisfactorily prevented. Therefore, superior safety and reliability of the cell can be obtained. (II) Metallic lithium can be used easily as the anode (so called “metallic lithium secondary cell” can be structured), which is difficult to be used in the electrolyte layer of liquid electrolyte; thus, the energy density can be further increased. (III) When a module in which plural unit cells are disposed in one case is structured, plural unit cells can be connected in series, which is impossible to be realized in the electrolyte layer of liquid electrolyte. Owing to this, a module, which provides various output voltages, particularly, comparatively large output, can be structured. (IV) Compared to the case where an electrolyte layer formed of a liquid electrolyte is provided, flexibility of adoptable configuration of the cell is increased, and the cell can be easily structured compactly. Owing to this, the cell can be easily formed in accordance with the disposition conditions (conditions such as disposition location, size of disposition space and configuration of the disposition space) in the equipment such as a potable equipment in which the cell is mounted as the power source.

Also, the electrochemical element in accordance with the invention may be characterized in that the electrolyte layer consists of a separator of insulative porous substance and a liquid electrolyte or solid electrolyte impregnated in the separator. In this case also, when the solid electrolyte is used, a ceramics solid electrolyte, a solid polymer electrolyte or a gel electrolyte obtained by adding a gelatinizing agent to the liquid electrolyte can be used.

Further, the invention provides a producing method of a composite particle for electrode,

the method comprising a granulating step for forming a composite particle comprising an electrode active material, a conductive additive and a binder by bringing the conductive additive and the binder capable of binding the electrode active material and the conductive additive into a close contact with a particle consisting of the electrode active material to integrate with each other, and

the granulating step comprising:

a stock solution preparing step for preparing a stock solution comprising the binder, the conductive additive and a solvent;

a fluidized bed forming step for forming the particle consisting of the electrode active material into a fluidized bed by throwing the particle consisting of the electrode active material into a fluidizing bathe; and

a spray-drying step, in which the stock solution is sprayed into the fluidized bed comprising the particle consisting of the electrode active material, thereby the stock solution is allowed adhering to the particle consisting of the electrode active material and dried to remove the solvent from the stock solution adhered to the surface of the particle consisting of the electrode active material to bring the particle consisting of the electrode active material and the particle consisting of the conductive additive into a close contact with each other by means of the binder.

By carrying out the above-described granulating step, the composite particle for electrode in accordance with the invention, which has the above-described structure, can be formed easily and reliably. Therefore, by using the composite particle for electrode obtained by means of this producing method, an electrode having superior polarizing characteristics can be formed easily and reliably; and further, an electrochemical element having superior charging/discharging characteristics can be formed easily and reliably.

Here, in the granulating step of the producing method of the composite particle for electrode in accordance with the invention, the above wording “allow the conductive additive and the binder coming into a close contact with the particle consisting of the electrode active material to integrate with each other” means a state in which particle consisting of the conductive additive and particle consisting of the binder are allowed coming into contact with at least a portion of the surface of the particle consisting of the electrode active material. That is, in the surface of the particle consisting of the electrode active material, if a part thereof is covered by the particle consisting of the conductive additive and particle consisting of the binder, the entire thereof does not have to be covered thereby. The “binder” used in the granulating step of the producing method of the composite particle for electrode in accordance with the invention is an agent which is capable of binding the electrode active material and the conductive additive, which are used simultaneously.

In the producing method of the composite particle for electrode in accordance with the invention, in order to form the composite particle for electrode having the above-described structure more easily and reliably, in the granulating step, the temperature within the fluidizing bathe is preferably controlled to a temperature of 50° C. or more but does not largely exceed the melting point of the binder; more preferably, the temperature within the fluidizing bathe is controlled to 50° C. or more and the melting point or less of the binder. Depending on the type of the binder, the melting point of the binder is, for example, approximately 200° C. When the temperature within the fluidizing bathe is lower than 50° C., the following tendency appears largely; i.e., the solvent in the spray is dried insufficiently. When the temperature within the fluidizing bathe largely exceeds the melting point of the binder, the following tendency appears largely; i.e., the binder is molten and causes a large problem for forming the particles. When the temperature within the fluidizing bathe is at a temperature slightly larger than the melting point of the binder, depending on the conditions, the above problem can be satisfactorily prevented from appearing. Also, when the temperature within the fluidizing bathe is lower than the melting point of the binder, the above problem does not appear.

Further, in the producing method of the composite particle for electrode in accordance with the invention, in order to form the composite particle for electrode having the above-described structure more easily and reliably, in the granulating step, the airflow generated within the fluidizing bathe is preferably an airflow of air, nitrogen gas, or inactive gas. Further, in the granulating step, the humidity within the fluidizing bathe (relative humidity) is preferably 30% or less in the above preferred temperature range.

In the producing method of the composite particle for electrode in accordance with the invention, in the granulating step, the solvent comprised in the stock solution is preferably capable of dissolving or dispersing the binder as well as capable of dispersing the conductive additive. Owing to this also, the dispersion level of the binder, the conductive additive and the electrode active material in the obtained composite particles for electrode can be more increased. In order to further increase the dispersion level of the binder, the conductive additive and the electrode active material in the composite particle for electrode, it is more preferred that the solvent comprised in the stock solution is capable of dissolving the binder as well as capable of dispersing the conductive additive.

Further, the producing method of the composite particle for electrode in accordance with the invention may be characterized by using a conductive polymer as the binder. Owing to this, in the obtained composite particle for electrode, the conductive polymer is additionally comprised. The above-described polymer electrode can be formed using the composite particle for electrode. The conductive polymer may have the ion conductivity or the electron conductivity. In the case where the conductive polymer has the ion conductivity, an extremely satisfactory ion conduction path (ion conduction network) can be established more easily and reliably in the active material-containing layer for electrode. In the case where the conductive polymer has the electron conductivity, an extremely satisfactory electron conduction path (electron conduction network) can be established more easily and reliably in the active material-containing layer for electrode.

In the producing method of the composite particle for electrode in accordance with the invention, in the granulating step, a conductive polymer may be additionally dissolved in the stock solution. In this case also, in the obtained composite particle for electrode, the conductive polymer is additionally comprised. The above-described polymer electrode can be formed using the composite particle for electrode. The conductive polymer may have the ion conductivity or the electron conductivity. In the case where the conductive polymer has the ion conductivity, an extremely satisfactory ion conduction path (ion conduction network) can be established more easily and reliably in the active material-containing layer for electrode. In the case where the conductive polymer has the electron conductivity, an extremely satisfactory electron conduction path (electron conduction network) can be established more easily and reliably in the active material-containing layer for electrode.

By using the composite particle for electrode obtained by means of the above-described producing method of the composite particle for electrode in accordance with the invention, an electrode having superior polarizing characteristics can be obtained easily and reliably. Further, by using the electrode for at least one of, more preferably, both of the anode and the cathode, an electrochemical element having more superior charging/discharging characteristics can be formed easily and reliably.

Further, the invention provides a producing method of an electrode comprising at least a conductive active material-containing layer which comprises an electrode active material, and a current collector disposed in a state being in electrically contact with the active material-containing layer,

the method comprising:

a granulating step of forming a composite particle comprising an electrode active material, a conductive additive and a binder by bringing the conductive additive and the binder capable of binding the electrode active material and the conductive additive into a close contact with the particle consisting of the electrode active material to integrate with each other; and

a forming step of an active material-containing layer for forming the active material-containing layer in a portion of the collector to be formed with the active material-containing layer using the composite particle, and

the granulating step comprising:

a stock solution preparing step for preparing a stock solution comprising the binder, the conductive additive and a solvent;

a fluidized bed forming step for forming the particle consisting of the electrode active material into a fluidized bed by throwing the particle consisting of the electrode active material into a fluidizing bathe; and

a spray-drying step, in which the stock solution is sprayed into the fluidized bed comprising the particle consisting of the electrode active material, thereby the stock solution is allowed adhering to the particle consisting of the electrode active material and dried to remove the solvent from the stock solution adhered to the surface of the particle consisting of the electrode active material to bring the particle consisting of the electrode active material and the particle of the conductive additive into a close contact with each other by means of the binder.

By carrying out the above-described granulating step, the composite particle, which serves as the constituent material for electrode in accordance with the invention, which has the above-described structure, can be formed easily and reliably. Therefore, by using the composite particle obtained by means of this producing method, the electrode having superior power density and polarizing characteristics can be formed easily and reliably; and further, the electrochemical element having superior charging/discharging characteristics can be formed easily and reliably.

Here, in the granulating step of the producing method of the electrode in accordance with the invention, the above wording “allow the conductive additive and the binder coming into a close contact with the particle consisting of the electrode active material to integrate with each other” means a state in which the particle consisting of the conductive additive and the particle consisting of the binder are allowed coming into contact with at least a portion of the surface of the particle consisting of the electrode active material. That is, in the surface of the particle consisting of the electrode active material, if a part thereof is covered by the particle consisting of the conductive additive and particle consisting of the binder, the entire thereof does not have to be covered thereby. The “binder” used in the granulating step of the producing method of the composite particle in accordance with the invention is an agent which is capable of binding the electrode active material and the conductive additive, which are used simultaneously.

In the producing method of the electrode in accordance with the invention, in order to form the composite particle having the above-described structure more easily and reliably, in the granulating step, the temperature within the fluidizing bathe is preferably controlled to a temperature of 50° C. or more but does not largely exceed the melting point of the binder; more preferably, the temperature within the fluidizing bathe is controlled to 50° C. or more and the melting point or less of the binder. Depending on the type of the binder, the melting point of the binder is controlled to, for example, approximately 200° C. When the temperature within the fluidizing bathe is lower than 50° C., the following tendency appears largely; i.e., the solvent in the spray is dried insufficiently. When the temperature within the fluidizing bathe largely exceeds the melting point of the binder, the following tendency appears; i.e., the binder is molten and causes a large problem for forming the particle. When the temperature within the fluidizing bathe is at a temperature slightly larger than the melting point of the binder, depending on the conditions, the above problem can be satisfactorily prevented from appearing. Also, when the temperature within the fluidizing bathe is lower than the melting point of the binder, the above problem does not appear.

Further, in the producing method of the composite particle in accordance with the invention, in order to form the composite particle having the above-described structure more easily and reliably, in the granulating step, the airflow generated within the fluidizing bathe is preferably an airflow formed of air, nitrogen gas, or inactive gas. Further, in the granulating step, the humidity within the fluidizing bathe (relative humidity) is preferably 30% or less in the above preferred temperature range. The wording “inactive gas” means a gas belongs to the noble gas.

In the producing method of the composite particle in accordance with the invention, in the granulating step, the solvent comprised in the stock solution is preferably capable of dissolving or dispersing the binder as well as capable of dispersing the conductive additive. Owing to this also, the dispersion level of the binder, the conductive additive and the electrode active material in the composite particle can be more increased. In order to further increase the dispersion level of the binder, the conductive additive and the electrode active material in the composite particle for electrode, it is more preferred that the solvent comprised in the stock solution is capable of dissolving the binder as well as capable of dispersing the conductive additive.

In the producing method of the electrode in accordance with the invention, in the granulating step, a conductive polymer may be additionally dissolved in the stock solution. In this case also, in the obtained composite particle, the conductive polymer is additionally comprised. The above-described polymer electrode can be formed using the composite particle. The conductive polymer may have the ion conductivity or the electron conductivity. In the case where the conductive polymer has the ion conductivity, an extremely satisfactory ion conduction path (ion conduction network) can be established more easily and reliably in the active material-containing layer for electrode. In the case where the conductive polymer has the electron conductivity, an extremely satisfactory electron conduction path (electron conduction network) can be established more easily and reliably in the active material-containing layer for electrode.

Further, the producing method of the electrode in accordance with the invention may be characterized by using a conductive polymer as the binder. Owing to this, in the obtained composite particle, the conductive polymer is additionally comprised. The above-described polymer electrode can be formed using the composite particle. The conductive polymer may have the ion conductivity or the electron conductivity. In the case where the conductive polymer has the ion conductivity, an extremely satisfactory ion conduction path (ion conduction network) can be established more easily and reliably in the active material-containing layer for electrode. In the case where the conductive polymer has the electron conductivity, an extremely satisfactory electron conduction path (electron conduction network) can be established more easily and reliably in the active material-containing layer for electrode.

By using the composite particle obtained by means of the above-described producing method of the electrode in accordance with the invention, an electrode having superior polarizing characteristics can be obtained easily and reliably. Further, by using the electrode for at least one of, more preferably, both of the anode and the cathode, the electrochemical element having more superior charging/discharging characteristics can be formed easily and reliably.

In the forming method of the electrode of the invention, the forming step of the active material-containing layer preferably comprises: a sheet forming step in which sheet is formed by carrying out a heat treatment and a pressure treatment on fine particles comprising at least the composite particle to obtain a sheet comprising at least the composite particle, and a disposing step of the active material-containing layer for disposing the sheet on the collector as the active material-containing layer.

As described above, in the forming step of the active material-containing layer, by forming the active material-containing layer using the composite particle by means of the dry method, the electrode, in which the internal resistance is satisfactorily reduced, and which has superior electrode characteristics capable of easily and satisfactorily increasing the power density of the electrochemical element, can be obtained more reliably. Particularly, in this case, an electrode of which thickness of the active material-containing layer is relatively thick and has a large output (for example, an electrode in which thickness of the active material-containing layer is 80 to 120 μm or less), which has been difficult to form by means of not only the conventional dry method, needles to say, but also wet processing, can be easily produced.

Here, the “fine particles comprising at least the composite particle” may consist of the composite particle only. Also, in the “fine particles comprising at least the composite particle”, the binder and/or the conductive additive may further comprised. When constituents other than the composite particle are comprised in the fine particles, the percentage of the composite particle within the fine particles is preferably 80% by mass or more on the basis of the total mass of the fine particles.

Also, in this case, it may be characterized in that a first heating member is the collector. Owing to this, the process, in which the produced active material-containing layer is brought into electrical contact with the collector, can be eliminated; and thus, the working efficiency may be increased.

In the producing method of the electrode in accordance with the invention, the sheet-forming step is preferably carried out using a heat roll pressing machine. The heat roll-pressing machine has a pair of heat rolls, and has an arrangement such that, between the pair of the heat rolls, the “fine particles comprising at least the composite particle” are thrown in and heated and pressurized to form sheet. Owing to this, the sheet, which serves as the active material-containing layer can be formed easily and reliably.

As described above, in the producing method of the electrode in accordance with the invention, in the forming step of the active material-containing layer, the active material-containing layer may be formed using the composite particle by means of the dry method. However, as described below, even when the active material-containing layer is formed by means of the wet processing, the above-described effect of the invention can be obtained.

That is, the forming step of the active material-containing layer may be characterized in that the forming step of the active material-containing layer comprises: a coating liquid preparing step for preparing a coating liquid for forming electrode by adding the composite particle to a liquid capable of dispersing or kneading the composite particle, a step for applying the coating liquid for forming an electrode to a portion of the collector to be formed with the active material-containing layer, and a step for solidifying the liquid film formed of the coating liquid for forming an electrode applied to a portion of the collector to be formed with the active material-containing layer.

In this case also, the electrode, in which the internal resistance is satisfactorily reduced and has superior electrode characteristics capable of easily and satisfactorily increasing the power density of the electrochemical element, can be obtained easily and reliably. Here, as for the “liquid capable of dispersing the composite particle,” a liquid, which does not dissolve the binder in the composite particle, is preferred. However, within a range that, in the process to form the active material-containing layer, the electrical contact among the composite particles is satisfactorily ensured, and the effect of the invention is obtained, such a liquid, which has such a characteristic to dissolve a part of the binder adjacent to the surface of the composite particle, may be used. Within a range that the effect of the invention is obtained, in the liquid capable of dispersing the composite particle, the binder and the conductive additive may be further added as another component of the composite particle. In this case, the binder added as another component is a binder, which is capable of being dissolved in the “liquid capable of dispersing the composite particle.”

Further, when a liquid, which is capable of being kneaded with the composite particle, is used, the forming step of the active material-containing layer may be characterized by comprising a kneaded product preparing step of preparing a kneaded product for forming electrode comprising the composite particle by adding the composite particle to the liquid, a step of applying the kneaded product for forming electrode to a portion to be formed with the active material-containing layer of the collector, and a step of solidifying the coating of the kneaded product for forming electrode applied to the portion to be formed with active material-containing layer of the collector.

In this case also, the electrode, in which the internal resistance is satisfactorily reduced and has superior electrode characteristics capable of easily and satisfactorily increasing the power density of the electrochemical element, can be obtained easily and reliably.

In the producing method of the electrode in accordance with the invention also, in order to increase the output of the electrochemical element more reliably by forming the active material-containing layer of the obtained electrode to be relatively thin, in the producing method of an electrode, thickness T of the active material-containing layer and average particle diameter d of the composite particles comprised in the active material-containing layer preferably satisfy the conditions expressed by following formulas (1) to (3):
0.0005≦(T/d)≦1 (1)
1 μm≦T≦150 μm (2)
1 μm≦d≦2000 μm (3).

Further, the invention provides a producing method of an electrochemical element provided with at least an anode, a cathode and an electrolyte layer having the ion conductivity, and having a structure such that the anode and the cathode are disposed opposite to each other being interposed by the electrolyte layer, wherein as the electrode for one or both of the anode and the cathode, an electrode, which is produced in accordance with the producing method of the electrode, is used.

By using the electrode obtained by means of the above-described producing method of the electrode in accordance with the invention to at least one of, preferably both of the anode and the cathode, even when the load requirements change sharply and largely, an electrochemical element, which has superior charging/discharging characteristics capable of satisfactorily responding thereto, can be obtained easily and reliably.

### BRIEF DESCRIPTION OF THE DRAWINGS

FIG. 1 is a schematic sectional diagram showing a basic structure of a preferred embodiment (lithium ion secondary cell) of an electrochemical element in accordance with the invention.

FIG. 2 is a schematic sectional diagram showing an example of a basic structure of a composite particle in accordance with the invention.

FIG. 3 is an illustration showing an example of granulating step when forming an electrode.

FIG. 4 is an illustration showing an example of a sheet-forming step when forming an electrode by means of the drying method.

FIG. 5 is an illustration showing an example of coating liquid preparing step when forming an electrode by means of the wet processing.

FIG. 6 is a schematic sectional diagram showing the internal structure in an active material-containing layer for electrode in accordance with the invention.

FIG. 7 is a schematic sectional diagram showing a basic structure of another embodiment of the electrochemical element in accordance with the invention.

FIG. 8 is a schematic sectional diagram showing a basic structure of still another embodiment of an electrochemical element in accordance with the invention.

FIG. 9 is an illustration showing a measuring method of internal resistance (impedance) of a composite particle for electrode in example 1.

FIG. 10 is an SEM photograph showing a section of an active material-containing layer for electrode (electric double layered capacitor), which is formed in accordance with the forming method (dry method) of the invention.

FIG. 11 is a TEM photograph showing a section (a portion identical to the portion shown in FIG. 9) of an active material-containing layer for electrode (electric double layered capacitor) formed in accordance with the forming method (dry method) of the invention.

FIG. 12 is an SEM photograph showing a section of an active material-containing layer for electrode (electric double layered capacitor), which is formed in accordance with the forming method (dry method) of the invention.

FIG. 13 is a TEM photograph showing a section (a portion identical to the portion shown in FIG. 11) of an active material-containing layer for electrode (electric double layered capacitor) formed in accordance with the forming method (dry method) of the invention.

FIG. 14 is an SEM photograph showing a section of an active material-containing layer for electrode (electric double layered capacitor), which is formed in accordance with the forming method (dry method) of the invention.

FIG. 15 is a TEM photograph showing a section (a portion identical to the portion shown in FIG. 13) of an active material-containing layer for electrode (electric double layered capacitor) formed in accordance with the forming method (dry method) of the invention.

FIG. 16 is an SEM photograph showing a section of an active material-containing layer for electrode (electric double layered capacitor), which is formed by a conventional forming method (wet method).

FIG. 17 is a TEM photograph showing a section (a portion identical to the portion shown in FIG. 15) of an active material-containing layer for electrode (electric double layered capacitor) formed by a conventional forming method (wet method).

FIG. 18 is an SEM photograph showing a section of an active material-containing layer for electrode (electric double layered capacitor), which is formed by a conventional forming method (wet method).

FIG. 19 is a TEM photograph showing a section (a portion identical to the portion shown in FIG. 18) of an active material-containing layer for electrode (electric double layered capacitor) formed by a conventional forming method (wet method).

FIG. 20 is an SEM photograph showing a section of an active material-containing layer for electrode (electric double layered capacitor), which is formed by a conventional forming method (wet method).

FIG. 21 is a TEM photograph showing a section (a portion identical to the portion shown in FIG. 20) of an active material-containing layer for electrode (electric double layered capacitor) formed by a conventional forming method (wet method).

FIG. 22 is a sectional diagram schematically showing partial structure of a conventional composite particle for electrode and the internal structure in an active material-containing layer for electrode formed using the conventional composite particles for electrode.

### BEST MODE FOR CARRYING OUT THE INVENTION

Hereinafter, preferred embodiments of the invention will be described in detail with reference to the drawings. In the following descriptions, identical or equivalent portions will be given with identical reference symbols and redundant descriptions therefore will be omitted.

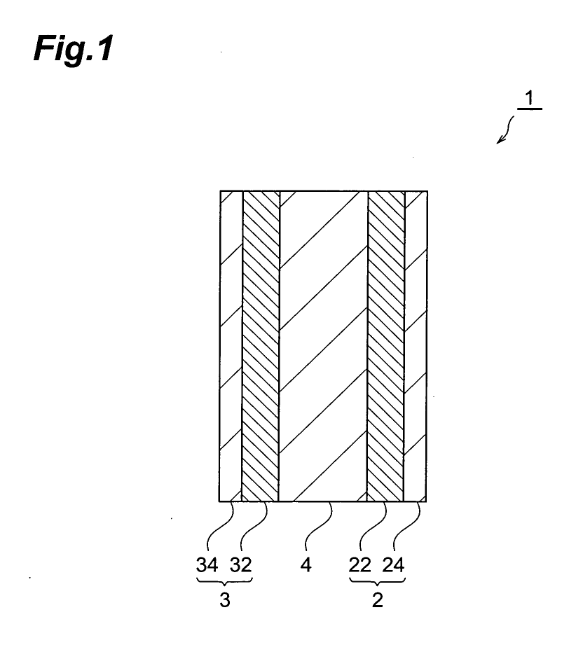

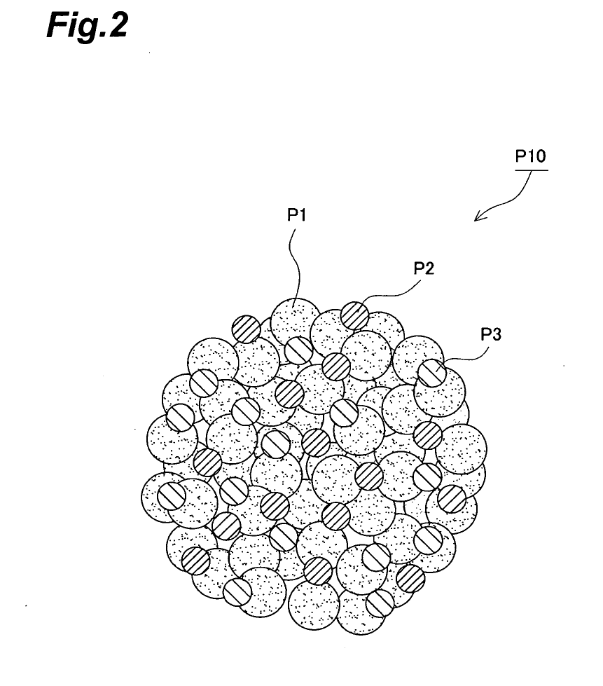

FIG. 1 is a schematic sectional diagram showing a basic structure of a preferred embodiment (lithium ion secondary cell) of an electrochemical element in accordance with the invention. FIG. 2 is a schematic sectional diagram showing an example of a basic structure of a composite particle, which is prepared in a granulating step on forming an electrode (an anode 2 and a cathode 3 in FIG. 1). Here, the electrode provided to the electrochemical element in accordance with the embodiment is a preferred example of the electrode in accordance with the invention. Also, the composite particle used as constituent material of such electrode is a preferred example of the composite particle for electrode in accordance with the invention.

The secondary cell 1 shown in FIG. 1 comprises, principally, an anode 2, a cathode 3 and an electrolyte layer 4 disposed between the anode 2 and the cathode 3.

Being provided with the anode 2 and the cathode 3 comprising composite particles P10 shown in FIG. 2, the secondary cell 1 shown in FIG. 1 is capable of charging and discharging satisfactorily enough to respond to the changes even when the load requirements change sharply and, in addition, largely.

The anode 2 of the secondary cell 1 shown in FIG. 1 is constituted of a collector 24 having a film-like (plate-like) shape and a film-like active material-containing layer 22 disposed between the collector 24 and the electrolyte layer 4. When charging, the anode 2 is connected to an anode of an external power source (both are not shown) and functions as the cathode. The configuration of the anode 2 is not particularly limited; but for example, a configuration of thin film as shown in FIG. 1 may be employed. As for the collector 24 of the anode 2, for example, a copper foil is employed.

Also, the film-like active material-containing layer 22 of the anode 2 mainly consists of the composite particle P10 shown in FIG. 2. Further, the composite particle P10 consists of a particle P1 consisting of an electrode active material, a particle P2 consisting of a conductive additive and a particle P3 consisting of a binder. The average particle diameter of the composite particle P10 is not particularly limited. The composite particle P10 has a structure such that the particle P1 consisting of the electrode active material and the particle P2 consisting of the conductive additive are not isolated from each other but electrically bound with each other. Accordingly, in the film-like active material-containing layer 22 also, a structure, in which the particle P1 consisting of the electrode active material and the particle P2 consisting of the conductive additive are not isolated from each other but electrically bound with each other, is formed.

The electrode active material constituting the composite particle P10 comprised in the anode 2 is not particularly limited, but publicly known electrode active materials may be used. For example, carbon materials such as graphite, hardly graphitizable carbon, easily graphitizable carbon and low temperature-calcined carbon, which are capable of storing and releasing lithium ion (intercalate, or doping and dedoping), metals such as Al, Si and Sn, which can form a compound with lithium, amorphous compounds, which mainly consist of an oxide such as SiO₂ or SnO₂, and lithium titanate (Li₃Ti₅O₁₂) and the like can be mentioned.

The conductive additive constituting the composite particle P10 comprised in the anode 2 is not particularly limited, but publicly known conductive additives may be used. For example, carbon materials such as carbon blacks, highly crystalline artificial graphite and natural graphite, fine powders of metal such as copper, nickel, stainless steel and iron, mixtures of the above carbon material and metal fine powder, and conductive oxides such as ITO can be mentioned.

If it is capable of binding the above particles of the electrode active material and the particle P2 consisting of the conductive additive, the binder constituting the composite particle P10 comprised in the anode 2 is not particularly limited. For example, fluorocarbon resins such as polyvinyliden fluoride (PVDF), polytetrafluoroethylene (PTFE), tetrafluoroethylene-hexafluoropropylene copolymer (FEP), tetrafluoroethylene-perfluoroalkylvinylether copolymer (PFA), ethylene-tetrafluoroethylene copolymer (ETFE), polychlorotrifluoroethylene (PCTFE), ethylene-chlorotrifluoroethylene-copolymer (ECTFE), polyvinyl fluoride (PVF) can be mentioned. The binder contributes not only to binding the above particle P1 consisting of electrode active material and the particle P2 consisting of the conductive additive but also to binding the foil (collector 24) and the composite particle P10.

Further, in addition to the above, for the binder, for example, vinyliden fluoride-based fluorocarbon rubber such as vinyliden fluoride-hexafluoropropylene-based fluorocarbon rubber (VDF-HFP-based fluorocarbon rubber), vinyliden fluoride-hexafluoropropylene-tetrafluoroethylene-based fluorocarbon rubber (VDF-HFP-TFE-based fluorocarbon rubber), vinyliden fluoride-pentafluoropropylene-based fluorocarbon rubber (VDF-PFP-based fluorocarbon rubber), vinyliden fluoride-pentafluoropropylene-tetrafluoroethylene-based fluorocarbon rubber (VDF-PFP-TFE-based fluorocarbon rubber), vinyliden fluoride-perfluoromethylvinylether-tetrafluoroethylene-based fluorocarbon rubber (VDF-PFMVE-TFE-based fluorocarbon rubber), vinyliden fluoride-chlorotrifluoroethylene-based fluorocarbon rubber (VDF-CTFE-based fluorocarbon rubber) may be used.

Further, in addition to the above, as for the binder, for example, polyethylene, polypropylene, polyethylene terephthalate, aromatic polyamide, cellulose, styrene-butadiene rubber, isoprene rubber, butadiene rubber, ethylene-propylene rubber and the like are may be used. Also, thermoplastic elastomeric polymer such as styrene-butadiene-styrene block copolymer and hydrogenated product thereof, styrene-ethylene-butadiene-styrene copolymer, styrene-isoprene-styrene block copolymer and hydrogenated product thereof may be used. Furthermore, syndiotactic 1,2-polybutadiene, ethylene-vinyl acetate copolymer, propylene-α-olefin (carbon number 2 to 12) copolymer and the like may be used. Still further, a conductive polymer may also be used.

Further, to the composite particle P10, particles consisting of a conductive polymer may be additionally added as the constituent of the composite particle P10. Further, when the electrode is formed by means of the drying method using the composite particle P10, it may be added to fine particles, which comprise at least the composite particle, as the constituent thereof. Also, in the case where the electrode is formed by means of the wet processing using the composite particle P10, when preparing a coating liquid or kneaded product comprising the composite particle P10, a particle consisting of a conductive polymer may be added as the constituent material of the coating liquid or kneaded product.

For example, if the conductivity based on the lithium ion is ensured, the conductive polymer is not particularly limited. For example, combined products of a monomer to be a polymer compound (polyether-based polymer compounds such as polyethylene oxide and polypropylene oxide, crosslinked polymer of polyether compound, polyepichlorohydrin, polyphosphazene, polysiloxane, polyvinylpyrrolidone, polyvinyliden carbonate, polyacrylonitrile, or the like) and lithium salts or lithium-based alkali metal salts such as LiClO₄, LiBF₄, LiPF₆, LiAsF₆, LiCl, LiBr, Li(CF₃SO₂)₂N and LiN(C₂F₅SO₂)₂, and the like can be mentioned. As for a polymerization initiator used for combining, for example, a photopolymerization initiator or thermal polymerization initiator, which is suitable for the above monomer, can be mentioned.

In order to form the secondary cell 1 into a metallic lithium secondary cell, the anode (not shown) thereof may be an electrode of metallic lithium or lithium alloy only, which also serves as the collector. The lithium alloy is not particularly limited, but for example, an alloy of Li—Al, LiSi, LiSn or the like (herein, LiSi is handled as an alloy) is available. In this case, the cathode is formed using composite particle P10, which has the constitution as described below.

The cathode 3 of the secondary cell 1 shown in FIG. 1 is constituted of a film-like collector 34 and a film-like active material-containing layer 32 disposed between the collector 34 and the electrolyte layer 4. When charging, the cathode 3 is connected to a cathode of an external power source (both are not shown) and functions as the anode. Also, the configuration of the cathode 3 is not particularly limited. For example, as shown in FIG. 1, the configuration may be a thin film. As for the collector 34 of the cathode 3, for example, aluminum foil may be used.

The electrode active material constituting the composite particle P10 comprised in the cathode 3 is not particularly limited. A publicly known electrode active material may be used. For example, lithium cobaltate (LiCoO₂), lithium nickelate (LiNiO₂), lithium manganese spinel (LiMn₂O₄), and composite metal oxide expressed by general formula: LiNiₓMn_{y}Co_{z}O₂ (x+y+z=1), lithium vanadium compound, V₂O₅, olivine form LiMPO₄ (M indicates Co, Ni, Mn or Fe), lithium titanate ((Li₃Ti₅O₁₂) and the like can be mentioned.

Further, as for the constituent elements other than the electrode active material constituting composite particle P10 comprised in the cathode 3, the same substances as those constituting the composite particle P10 comprised in the anode 2 may be used. The binder constituting the composite particle P10 comprised in the cathode 3 also contributes not only to binding the particle P1 consisting of the above-described electrode active material and the particle P2 consisting of the conductive additive, but also to bind the foil (collector 34) and the composite particle P10. As described above, the composite particle P10 has a structure such that the particle P1 consisting of the electrode active material and the particle P2 consisting of the conductive additive are not isolated from each other but electrically bound to each other. Therefore, in the active material-containing layer 32 also, a structure is formed in which the particle P1 consisting of the electrode active material and the particle P2 consisting of the conductive additive are not isolated from each other but electrically bound to each other.

Here, in order to form the contact boundary among the conductive additive, the electrode active material and the solid polymer electrolyte in a satisfactory size in three-dimensions, BET superficial area of the particle P1 consisting of the electrode active materials comprised in the above-described anode 2 and the cathode 3 is, in the case of the cathode 3, preferably 0.1 to 1.0 m²/g, more preferably 0.1 to 0.6 m²/g. And for the anode 2, the value is preferably 0.1 to 10 m²/g, and more preferably 0.1 to 5 m²/g. In the case of a double-layered capacitor, for both of the cathode 3 and anode 2, the value is preferably 500 to 3000 m²/g.

Further, from the same viewpoint, in the case of the cathode 3, the average particle diameter of the particles P1 consisting of the electrode active material is preferably 5 to 20 μm, more preferably 5 to 15 μm. In the case of the anode 2, the value is preferably 1 to 50 μm, more preferably 1 to 30 μm. Further, from the same viewpoint, the amount of the conductive additive and binder adhered to the electrode active material is, when expressed using a value of 100×(mass of conductive additive+mass of binder)/(mass of electrode active material), preferably 1 to 30% by mass, more preferably 3 to 15% by mass.

The electrolyte layer 4 may be a layer formed of electrolyte, or may be a layer formed of solid electrolyte (ceramics solid electrolyte, solid polymer electrolyte), or may be a layer formed of a separator and a liquid electrolyte impregnated in the separator and/or a solid electrolyte.

The liquid electrolyte is prepared by dissolving an electrolyte comprising lithium in a nonaqueous solvent. The electrolyte comprising lithium may be appropriately selected from, for example; LiClO₄, LiBF₄, LiPF₆ and the like; or lithium imide salts such as Li(CF₃SO₂)₂N, Li(C₂F₅SO₂)₂N, and LiB(C₂O₄)₂ or the like may also be used. The nonaqueous solvent may be selected from, for example, organic solvents such as ethers, ketones and carbonates, which are exemplified in Japanese Patent Application Laid-Open No. Show 63-121260 and the like. In the invention, particularly, carbonates are preferably used. Among the carbonates, particularly, a mixed solvent comprising ethylene carbonate as the main component and added with one or more other solvents is preferably used. The mixing ratio is, ordinarily, preferably ethylene carbonate: another solvent=5 to 70:95 to 30 (volume ratio). Since ethylene carbonate has a high freezing point as 36.4° C., and is solidified at room temperature, it cannot be used as the electrolyte for a cell by itself. However, by adding one or more other solvents having a low freezing point, the freezing point of the mixed solvent is reduced to make ethylene carbonate usable. As for the other solvents, any solvents that lower the freezing point of ethylene carbonate may be used. For example, diethlcarbonate, dimethyl carbonate, propylene carbonate, 1,2-dimethoxyethane, methyl ethyl carbonate, γ-butyrolactone, γ-valerolactone γ-octanoic lactone, 1,2-diethoxyethane, 1,2-ethoxymethoxyethane, 1,2-dibutoxyethane, 1,3-dioxolan, tetrahydrofuran, 2-methyl-tetrahydrofuran, 4,4-dimethyl-1,3-dioxane, butylene carbonate, methyl formate and the like can be mentioned. By using a carbonaceous material as the active material for anode and the above mixed solvent, the cell capacity is largely increased, and the irreversible capacity ratio can be satisfactorily lowered.

As for the solid polymer electrolyte, for example, a conductive polymer having ion conductivity is available.

If the conductivity of the lithium ion is ensured, the conductive polymer is not particularly limited. For example, combined products of a monomer to be a polymer compound (polyether-based polymer compounds such as polyethylene oxide and polypropylene oxide, crosslinked polymer of polyether compound, polyepichlorohydrin, polyphosphazene, polysiloxane, polyvinylpyrrolidone, polyvinyliden carbonate, polyacrylonitrile, or the like) and lithium salts or lithium-based alkali metal salts such as LiClO₄, LiBF₄, LiPF₆, LiAsF₆, LiCl, LiBr, Li(CF₃SO₂)₂N and LiN(C₂F₅SO₂)₂, and the like can be mentioned. As for a polymerization initiator used for combining, for example, a photopolymerization initiator or thermal polymerization initiator, which is suitable for the above monomer, can be mentioned.

Further, as for a supporting salt constituting the polymer solid electrolyte, for example, salts such as LiClO₄, LiPF₆, LiBF₄, LiAsF₆, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂) and LiN(CF₃CF₂CO)₂, and mixtures thereof are available.

When a separator is used in the electrolyte layer 4, as for the constituent material, for example, one or two or more kinds of polyolefins such as polyethylene and polypropylene (when two kinds or more, a laminated product of two or more films is available), polyesters such as polyethylene terephthalate, thermoplastic fluorocarbon resins such as ethylene-tetrafluoroethylene copolymer, and celluloses are available. As for the configuration of the sheet, a film of microporous membrane with the air permeability measured in accordance with the method prescribed in JIS-P8117 of 5 to 2000 sec/100 cc or so, thickness of 5 to 100 μm or so, a woven textile and a nonwoven cloth are available. A monomer of a solid electrolyte may be used after being impregnated in the separator and hardened to form polymer. Also, the above-described liquid electrolyte may be used after being impregnated into a porous separator.

Next, a preferred embodiment of the producing method of the electrode in accordance with the invention will be described. In the producing method of the electrode described below, a preferred example of the producing method of the composite particle for electrode in accordance with the invention is comprised.

First of all, the producing method of the composite particle P10 will be described. The composite particle P10 is prepared through a granulating step in which the particle P1 consisting of the electrode active material is brought into close contact with the conductive additive and the binder to integrate with each other to form the composite particle comprising the electrode active material, the conductive additive and the binder.

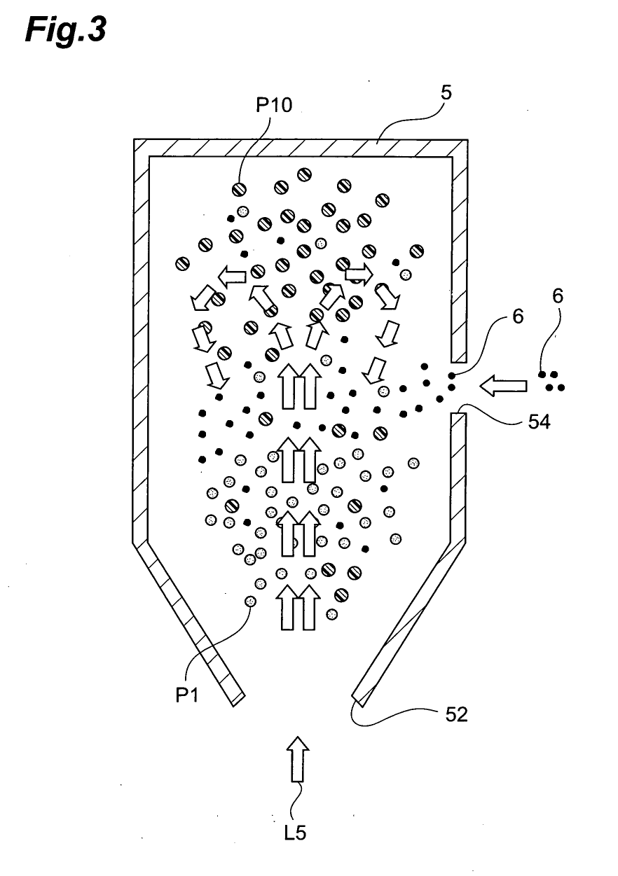

The above-described granulating step will be described more particularly referring to FIG. 3. FIG. 3 is an illustration showing an example of the granulating step when producing the composite particle.

The granulating step comprises the following steps; i.e., a stock solution preparing step, in which a stock solution comprising the binder, the conductive additive and a solvent is prepared, a fluidized bed forming step, in which an airflow is generated in a fluidizing bathe and the particle consisting of an electrode active material is thrown into the airflow to form a fluidized bed with the particle consisting of the electrode active material, and a spray-drying step, in which the stock solution is sprayed into the fluidized bed comprising the particle consisting of the electrode active material to allow the stock solution adhering to the particle consisting of the electrode active material to dry and remove the solvent from the stock solution adhered to the surface of the particle consisting of the electrode active material, and bring the particle consisting of the electrode active material and the particle consisting of the conductive additive into a close contact by means of the binder.

First of all, in the stock solution preparing step, using a solvent capable of dissolving the binder, the binder is dissolved in the solvent. Then, the conductive additive is dispersed in the obtained solution to obtain the stock solution. In this stock solution preparing step, a solvent (dispersion medium) capable of dispersing the binder may be used.

Then, in the fluidized bed forming step, an airflow is generated within the fluidizing bathe 5 as shown in FIG. 3, and the particle P1 consisting of the electrode active material is thrown into the airflow; thereby the fluidized bed is formed with the particle consisting of the electrode active material.

Then, in the spray-drying step, as shown in FIG. 3, the drop of raw material 6 is sprayed within the fluidizing bathe 5; thereby the drop of raw material 6 is allowed adhering to the particle P1 consisting of the electrode active material having been fluidized. At the same time, the particle is dried within the fluidizing bathe 5 to remove the solvent from the drop of raw material 6 adhered on the surface of the particle P1 consisting of the electrode active material, and bring the particle P1 consisting of the electrode active material and the particle P2 consisting of the conductive additive into close contact with each other by means of the binder; thus, the composite particle P10 is obtained.

In particular, the fluidizing bathe 5 is a container having, for example, a cylindrical shape. In the bottom portion of the bathe, an opening 52 is formed for introducing warm air (or hot air) L5 from the outside to cause the particles consisting of the electrode active material to convect within the fluidizing bathe 5. Also, in the side face of the fluidizing bathe 5, an opening 54 is formed for introducing the drop of raw material 6 to be sprayed to the particles consisting of the electrode active material P1 being convected within the fluidizing bathe 5. The drop of raw material 6 comprising the binder, the conductive additive and the solvent is sprayed to the particle P1 consisting of the electrode active material being convected within the fluidizing bathe 5.

Here, the temperature of the ambient atmosphere where the particles consisting of the electrode active material P1 are placed is maintained to a prescribed temperature at which the solvent in the drop of raw material 6 can be removed swiftly (preferably, to a temperature range of 50° C. to a degree not largely exceeding the melting point of the binder, more preferably, to a temperature range from 50° C. to the melting point or less of the binder (for example, 200° C.)) by controlling, for example, the temperature of the warm air (or hot air), or the like. Thus, the liquid film of the stock solution, which is formed on the surface of the particle P1 consisting of the electrode active material, is dried substantially at the same time when the drop of raw material 6 is sprayed. Owing to this, the binder and the conductive additive are brought into a close contact with the surface of the particle consisting of the electrode active material; thus the composite particle P10 is obtained.

The solvent capable of dissolving the binder is not particularly limited if it can dissolve the binder and disperse the conductive additive. For example, N-methyl-2-pyrrolidone, N,N-dimethylformamide and the like are available.

Next, a preferred example of the forming method of the electrode using the composite particle P10 will be described.

(Dry Method)

First of all, a case will be described where an electrode is formed, using the composite particle P10 produced through the above-described granulating step, by means of the drying method in which no solvent is used.

In this case, the active material-containing layer is formed through the following forming step of the active material-containing layer. The forming step of the active material-containing layer comprises a sheet forming step in which fine particles P12 comprising at least the composite particle P10 is subjected to a heat treatment and a pressure treatment to form sheet to obtain sheet 18, which comprises at least the composite particle, and a disposing step of the active material-containing layer in which the sheet 18 is disposed on the collector as the active material-containing layer (active material-containing layer 22 or active material-containing layer 32).

The dry method is a method to form an electrode without using a solvent, which has the following advantages; i.e., 1) since no solvent is required, the dry method is safe; 2) since the particles only are extended being applied with pressure without using a solvent, the electrode (porous layer) can be easily built up in a high density; and 3) since no solvent is used, in the drying process of the liquid film formed of the coating liquid for forming an electrode having been applied on the collector, there occurs no agglomeration or uneven distribution of the particle P1 consisting of the electrode active material, particle P2 consisting of the conductive additive for imparting the conductivity and the particle P3 consisting of the binder, which are the problem in the wet processing method; and the like.

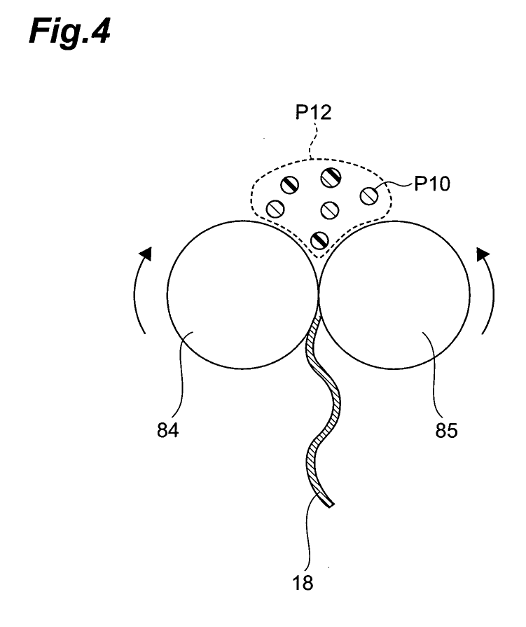

The sheet-forming step can be appropriately carried out using a heat roll pressing machine shown in FIG. 4.

FIG. 4 is an illustration showing an example of the sheet-forming step when forming the electrode by means of the drying method (when a heat roll pressing machine is used).

In this case, as shown in FIG. 4, between a pair of heat rolls 84 and 85 of a heat roll pressing machine (not shown), fine particles P12, which comprise at least the composite particle P10, are thrown in, and mixed and kneaded, and extended by being applying with heat and pressure to form the sheet 18. Here, the surface temperature of the heat rolls 84 and 85 is preferably 60 to 120° C., and the pressure is preferably 20 to 5000 kgf/cm.

Here, to the fine particles P12 comprising at least the composite particle P10, at least one kind of particles of the particle P1 consisting of the electrode active material, particle P2 consisting of the conductive additive for imparting the conductivity and the particle P3 consisting of the binder may be further mixed.

Also, before throwing into the heat roll pressing machine (not shown), fine particles P12 comprising at least the composite particle P10 may be previously kneaded using a mixing device such as a mill.

The collector and the active material-containing layer may be brought into electrical contact with each other after the active material-containing layer is formed by the heat roll-pressing machine. However, it may be arranged so that the collector and the constituent material for the active material-containing layer having been spread over one surface of the collector are supplied to the heat rolls 84 and 85; thus, the sheet of the active material-containing layer may be formed, and the electrical connection between the active material-containing layer and the collector may be established simultaneously.

Also, to reliably obtain a high power output of the electrochemical element by forming the active material-containing layer of the obtained electrode to be comparatively thin, it is preferred to form the active material-containing layer in the forming step of the active material-containing layer, so that, thickness T of the active material-containing layer and average particle diameter d of the composite particles comprised in the active material-containing layer satisfy the conditions expressed by the following formulas (1) to (3). In particular, in the sheet forming step in the forming step of the active material-containing layer, 1) by controlling the amount of the fine particles P12 comprising at least the composite particle P10 to be spread over the surfaces of the heat rolls 84 and 85; 2) by controlling the gap between the heat rolls 84 and 85, or 3) by controlling the pressure when the heat rolls 84 and 85 press fine particles P12, the conditions expressed by the following formulas (1) to (3) can be satisfied:
0.0005≦(T/d)≦1 (1)
1 μm≦T≦150 μm (2)
1 μm≦d≦2000 μm (3).

(Wet Processing)

Next, a preferred example will be described, in which a coating liquid for forming an electrode is prepared using the composite particle P10 produced through the above-described granulating step and an electrode is formed using the same. First of all, an example for preparing the coating liquid for forming an electrode will be described.

The coating liquid for forming an electrode can be obtained in the following manner. That is, a mixture is prepared, in which the composite particle P10 produced through the granulating step, a liquid capable of dispersing or dissolving the composite particle P10 and a conductive polymer to be added on the basis of necessity are mixed; and a part of the liquid is removed from the mixed liquid to control to an appropriate viscosity for application.

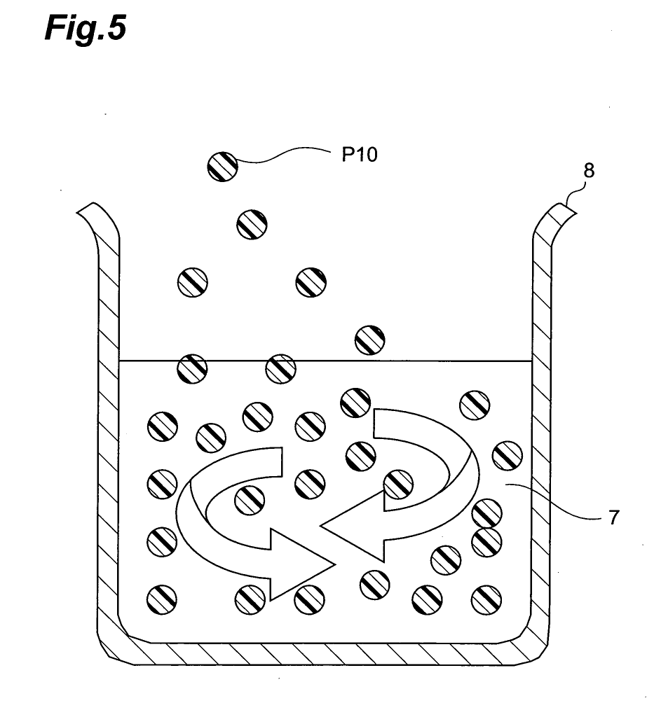

In particular, when a conductive polymer is used, as shown in FIG. 5, for example, in the container 8 having a prescribed stirring device (not shown) such as a stirrer or the like, by mixing a liquid capable of dispersing or dissolving the composite particle P10 and the conductive polymer or a monomer, which is the constituent material for the conductive polymer, the mixture is prepared. Then, the composite particle P10 is added to the mixture and stirred satisfactorily; thus, the coating liquid for forming an electrode 7 is prepared.

Next, a preferred embodiment of the producing method of the electrode in accordance with the invention using the coating liquid for forming an electrode will be described. First of all, the coating liquid for forming an electrode is applied on the surface of the collector to form a liquid film of the coating liquid on the surface. Then, the liquid film is dried to form the active material-containing layer on the collector; thus, formation of the electrode is completed. The technique to apply the coating liquid for forming an electrode to the surface of the collector is not particularly limited, but should be appropriately determined corresponding to the material, configuration or the like of the collector. For example, such methods as metal mask printing, electrostatic coating, dip coating, spray coating, roll coating, doctor blade coating, gravure coating and screen-printing are available.

Also, to reliably obtain a high power output of the electrochemical element by forming the active material-containing layer of the obtained electrode to be comparatively thin, it is preferred to form the active material-containing layer in the forming step of the active material-containing layer, so that, thickness T of the active material-containing layer and average particle diameter d of the composite particles comprised in the active material-containing layer satisfy the conditions expressed by the following formulas (1) to (3). In particular, when the liquid film of the coating liquid for forming an electrode is formed on the surface of the collector, the application amount of the coating liquid for forming an electrode is controlled.
0.0005≦(T/d)≦1 (1)
1 μm≦T≦150 μm (2)
1 μm≦d≦2000 μm (3).

As for the technique to form the active material-containing layer from the liquid film of the coating liquid for forming an electrode, in addition to the drying method, a technique such that, when forming active material-containing layer from the liquid film of the coating liquid, hardening reaction among the constituents in the liquid film (for example, polymerization reaction of a monomer to be the constituent material of a conductive polymer) may be accompanied. For example, when a coating liquid for forming an electrode, which comprises a monomer to become a constituent material of a UV hardening resin (conductive polymer), is used, first of all, the coating liquid for forming an electrode is applied on the collector in the above-described prescribed method. Then, ultraviolet ray is irradiated to the liquid film of the coating liquid; thereby, the active material-containing layer is formed.

In this case, compared to the case where the conductive polymer (particles consisting of conductive polymer) is previously comprised in the coating liquid for forming an electrode, by generating conductive polymer after forming the liquid film of the coating liquid for forming an electrode on the collector and allowing the monomer polymerizing in the liquid film, while satisfactory state of dispersion of the composite particle P10 in the liquid film is substantially maintained, the conductive polymer can be generated in the spaces among the composite particles P10. Therefore, the state of dispersion of the composite particle P10 and the conductive polymer in the obtained active material-containing layer can be formed more satisfactorily.

That is, an ion conduction network and electron conduction network, in which further fine and dense particles (particles consisting of the composite particle P10 and the conductive polymer) are integrated with each other, can be established in the obtained active material-containing layer. Therefore, in this case, a polymer electrode, which has superior polarizing characteristics capable of satisfactorily advancing the electrode reaction even in a range of comparatively low operation temperatures, can be obtained further easily and reliably.

Further, in this case, the polymerization reaction of the monomer as the constituent material of the UV curing resin can be advanced by the ultraviolet ray irradiation.

Further, on the basis of necessity, the obtained active material-containing layer may be subjected to an extending processing by applying pressure using a heat plate press or heat rolls to form sheet.

In the above descriptions, as an example of forming method of the electrode using the composite particle P10, there has been described about the case in which the coating liquid for forming an electrode 7 comprising the composite particle P10 is prepared, and using the same, the electrode is formed. However, the forming method of the electrode using the composite particle P10 (wet processing) is not limited to the above.

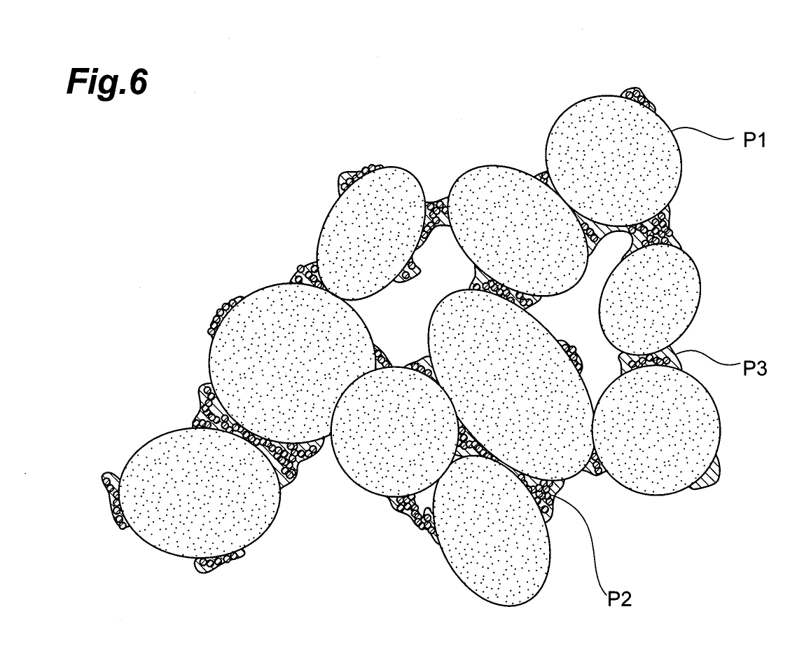

In the active material-containing layer (active material-containing layer 22 or active material-containing layer 32) formed in accordance with the above-described wet processing method or dry method, an internal structure as schematically shown in FIG. 6 is formed. That is, in the active material-containing layer (the active material-containing layer 22 or the active material-containing layer 32), even when the particle P3 consisting of the binder is used, the particle P1 consisting of the electrode active material and the particle P2 consisting of the conductive additive are not isolated from each other, but such structure that the particles thereof are electrically bound to each other is formed.

Hereinbefore, preferred embodiments of the invention have been described. But the invention is not limited to the above-described embodiments.

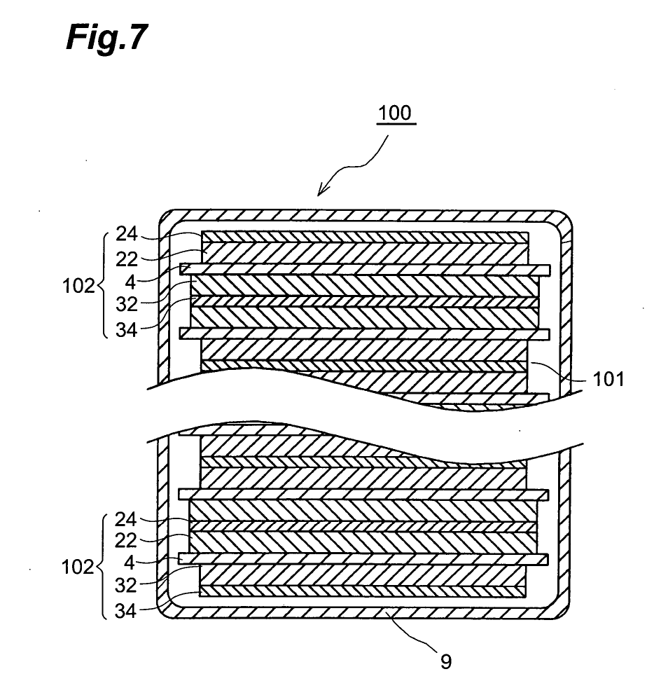

For example, it is necessary for the electrode in accordance with the invention only that the active material-containing layer is formed using the composite particle P10 comprised in the coating liquid for forming an electrode in accordance with the invention. The structure other than that is not particularly limited. Also, it is necessary for an electrochemical element only that the electrode in accordance with the invention is provided as at least one electrode of the anode and cathode. The constitution and structure other than that is not particularly limited. For example, in the case where the electrochemical element is a cell, as shown in FIG. 7, a structure of a module 100 such that plural unit cells (a cell comprising an anode 2, a cathode 3 and an electrolyte layer 4, which also serves as a separator) 102 are piled up and held in a state sealed in a prescribed case 9 (packaged), may be employed.

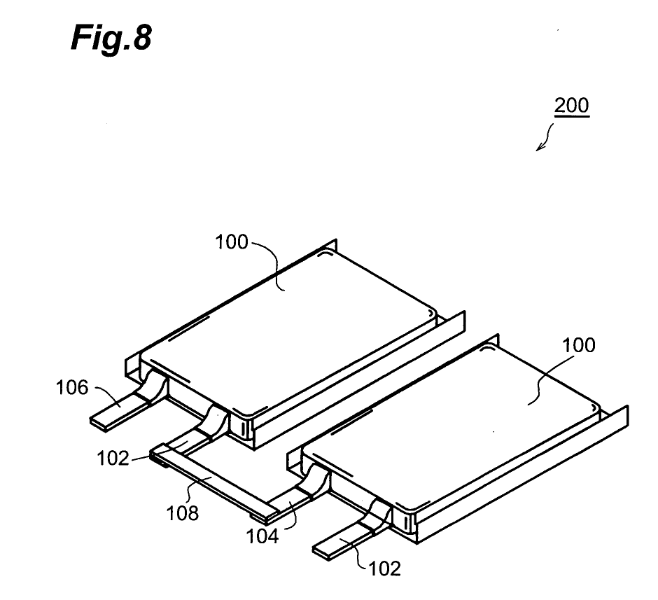

Further, in this case, each of the unit cells may be connected to each other in parallel or in series. Further, for example, a cell unit such that plural modules 100 are electrically connected to each other in series or in parallel may be structured. Like a cell unit 200 shown in FIG. 8, for example, a cell unit 200 of serial connection may be structured by electrically connecting a cathode terminal 104 of one module 100 to an anode terminal 106 of another module 100 via a metal piece 108.

Further, when forming the above-described module 100 and cell unit 200, the same protection circuit (not shown) or PTC (not shown) as those provided to existing batteries may be additionally provided thereto.

In the above descriptions of the embodiments of the electrochemical element, the electrochemical element, which has a constitution of secondary cell, has been described. But, for example, it is sufficient that the electrochemical element according to the invention is provided with at least an anode, a cathode and an electrolyte layer having ion conductivity, and has such structure that the anode and the cathode are disposed opposing to each other being interposed by the electrolyte layer. Therefore a primary cell is also applicable. As for the electrode active material for the composite particle P10, in addition to above-exemplified substances, materials used for existing primary cells may be employed. The conductive additive and the binder may be the same as the above-exemplified substances.

Further, the electrode according to the invention is not limited to an electrode for cell. For example, it may be an electrode used for an electrolytic cell, electrochemical capacitor (electric double layered capacitor, aluminum electrolytic capacitor etc.) or electrochemical sensor. The electrochemical element according to the invention also is not limited to a cell only. For example, it may be an electrolytic cell, electrochemical capacitor (electric double layered capacitor, aluminum electrolytic capacitor etc.) or electrochemical sensor. For example, in the case of an electrode for electric double layered capacitor, as for the electrode active material constituting the composite particle P10, a carbon material having a high electric double layer capacitance such as palm shell activated carbon, pitch-based activated carbon, phenol resin activated carbon or the like may be used.

Further, as an anode used for, for instance, brine electrolysis, for example, an electrode may be formed by using a thermally decomposed product of ruthenium oxide (or composite oxide of ruthenium oxide and metal oxide other than that) as the electrode active material in the invention to be the constituent material of the composite particle P10, and forming the active material-containing layer comprising the obtained composite particle P10 on a titanium substrate.

In the case where the electrochemical element in accordance with the invention is an electrochemical capacitor, the electrolyte solution is not particularly limited. A nonaqueous electrolyte solution (nonaqueous electrolyte solution using organic solvent), which is used for an electrochemical capacitor such as a publicly known electric double-layered capacitor, may be used.

Further, the kind of the nonaqueous electrolyte solution 30 is not particularly limited. However, generally, the kind is selected while taking into consideration the solubility and degree of disassociation of the solute and the viscosity of the liquid. A nonaqueous electrolyte solution having a high conductivity and high potential window (high decomposition starting voltage) is preferred. As for the organic solvent, propylene carbonate, diethylene carbonate and acetonitrile are available. As for the electrolyte, for example, quaternary ammonium salts such as tetraethylammonium tetrafluoroborate (borontetrafluoride tetraethylammonium) is available. In this case, contained water should be strictly controlled.

### EXAMPLES

Hereinafter, the invention will be described further in detail while giving examples and comparative examples. However, the invention is not limited to the following examples.

### Example 1

In accordance with the procedure described below, the composite particle for electrode, which can be used for forming the active material-containing layer for the cathode of lithium ion secondary cell, was produced in accordance with the above-described granulating step. The composite particle P10 for electrode was formed of an electrode active material for the cathode (90% by mass), a conductive additive (6% by mass) and a binder (4% by mass).

As for the electrode active material for the cathode, from the composite metal oxide expressed by a general formula: LiₓMn_{y}Ni_{z}Co_{1-x-y}O_{w}, particles of a composite metal oxide (BET specific surface area: 0.55 m²/g, average particle diameter: 12 μm), which satisfied the conditions of x=1, y=0.33, z=0.33 and w=2, was used. As for the conductive additive, acetylene black was used. Further, as for the binder, polyvinyliden fluoride was used.

First of all, in the stock solution preparing step, a “stock solution” (acetylene black of 3% by mass, polyvinyliden fluoride of 2% by mass) was prepared by dispersing acetylene black in the solution in which polyvinyliden fluoride was dissolved in N,N-dimethylformamide [(DMF): solvent].

Then, in the fluidized bed-forming step, airflow formed of the air was generated within a container, which had the same structure as that of the fluidizing bathe 5 shown in FIG. 3, fine particles of the composite metal oxide were thrown in to form a fluidized bed. Then, in the spray-drying step, the above-described stock solution was sprayed to the fine particles of the composite metal oxide in the state of fluidized bed to allow the solution adhering to the surface of fine particles. By maintaining the temperature of the ambient atmosphere in which the fine particles to be sprayed were placed to a fixed level, substantially simultaneously with the spraying, N,N-dimethylformamide was removed from the surface of fine particles. Thus, the acetylene black and the polyvinyliden fluoride were brought into a close contact with the surface of fine particles; thus, the composite particle P10 for electrode (average particle diameter: 150 μm) was obtained.

The amount of the electrode active material, the conductive additive and the binder used in the granulating step was controlled respectively so that the mass ratio of these components within the finally obtained composite particles P10 for electrode agreed with the above-described values.

### Example 2

In accordance with the procedure described below, the composite particle for electrode, which can be used for forming the active material-containing layer for an anode of lithium ion secondary cell, was produced in accordance with the above-described granulating step. The composite particle P10 for electrode was constituted of an electrode active material for the anode (85% by mass), a conductive additive (5% by mass) and a binder (10% by mass).

As for the electrode active material for the anode, artificial graphite (BET specific surface area: 1.0 m²/g, average particle diameter: 30 μm) was used. As for the conductive additive, acetylene black was use. Further, as for the binder, polyvinyliden fluoride was used.

First of all, in the stock solution preparing step, a “stock solution” (acetylene black of 2% by mass, polyvinyliden fluoride of 4% by mass) was prepared by dispersing acetylene black in the solution in which polyvinyliden fluoride was dissolved in N,N-dimethylformamide [(DMF): solvent].

Then, in the spray-drying step, the above-described stock solution was sprayed to fine particles of an artificial graphite in a state of fluidized bed within a container, which has the same structure as that of the fluidizing bathe 5 shown in FIG. 3, to allow the solution adhering to the surface of fine particles. By maintaining the temperature of the ambient atmosphere in which the fine particles to be sprayed were placed to a fixed level, substantially simultaneously with the spraying, N,N-dimethylformamide was removed from the surface of fine particles. Thus, the acetylene black and the polyvinyliden fluoride were brought into a close contact with the surface of fine particles; thus, the composite particle P10 for electrode (average particle diameter: 300 μm) was obtained.

The amount of the electrode active material, the conductive additive and the binder used in the granulating step was controlled respectively so that the mass ratio of these components within the finally obtained composite particles P10 for electrode agreed with the above-described values.

### Example 3

In accordance with the procedure described below, the composite particle for electrode, which can be used for forming the electrode of the electric double layered capacitor, was produced in accordance with the above-described granulating step. The composite particle P10 for electrode was constituted of an electrode active material for the anode (80% by mass), a conductive additive (10% by mass) and a binder (10% by mass).

As for the electrode active material, activated carbon (BET specific surface area: 2500 m²/g, average particle diameter: 20 μm) was used. As for the conductive additive, acetylene black was used. Further, as for the binder, polyvinyliden fluoride was used.

First of all, in the stock solution preparing step, a “stock solution” (acetylene black of 2% by mass, polyvinyliden fluoride of 2% by mass) was prepared by dispersing acetylene black in the solution in which polyvinyliden fluoride was dissolved in N,N-dimethylformamide [(DMF): solvent].

Then, in the spray-drying step, the above-described stock solution was sprayed to the fine particles of the artificial graphite in a state of fluidized bed within a container, which has the same structure as that of the fluidizing bathe 5 shown in FIG. 3, to allow the solution adhering to the surface of fine particles. By maintaining the temperature of the ambient atmosphere in which the fine particles to be sprayed were placed to a fixed level, substantially simultaneously with the spraying, N,N-dimethylformamide was removed from the surface of fine particles. Thus, the acetylene black and the polyvinyliden fluoride were brought into a close contact with the surface of fine particles; thus, the composite particle P10 for electrode (average particle diameter: 100 μm) was obtained.

The amount of the electrode active material, the conductive additive and the binder used in the granulating step was controlled respectively so that the mass ratio of these components within the finally obtained composite particles P10 for electrode agreed with the above-described values.

### Comparative Example 1

An electrode was produced in accordance with the conventional electrode producing procedure described below. First of all, using the same electrode active material, conductive additive and binder as those used in example 1, respectively, a kneaded product was obtained by mixing the above so that mass of the electrode active material:mass of the conductive additive:mass of the binder=90:6:4.

In particular, using a planetary mill and a homogenizer, a mixture of the electrode active material, the conductive agent and the binder was stirred and mixed. Then, using a heat roll apparatus, the kneaded product was formed into a sheet active material-containing layer, which had the same supporting amount of the electrode active material (50 mg/cm²) and the porosity (void ratio) (25%) as those of the composite particle P10 for electrode in example 1, was formed on an aluminum foil (collector).

### Comparative Example 2

An electrode was produced in accordance with the conventional electrode producing procedure described below. First of all, using the same electrode active material, conductive additive and binder as those used in example 2, respectively, a kneaded product was obtained by mixing the above so that mass of the electrode active material:mass of the conductive additive:mass of the binder=85:5:10.

In particular, using a planetary mill and a homogenizer, a mixture of the electrode active material, the conductive agent and the binder was stirred and mixed. Then, using a heat roll apparatus, the kneaded product was formed into a sheet active material-containing layer, which had the same supporting amount of the electrode active material (32 mg/cm²) and the porosity (void ratio) (35%) as those of the composite particles P10 for electrode in example 1, was formed on a copper foil (collector).

### Comparative Example 3

An electrode was produced in accordance with the conventional electrode producing procedure described below. First of all, using the same electrode active material, conductive additive and binder as those used in example 3, respectively, a kneaded product was obtained by mixing the above so that mass of the electrode active material:mass of the conductive additive:mass of the binder=80:10:10.

In particular, using a planetary mill and a homogenizer, a mixture of the electrode active material, the conductive agent and the binder was stirred and mixed. Then, using a heat roll apparatus, the kneaded product was formed into a sheet active material-containing layer, which had the same supporting amount of the electrode active material (10 mg/cm²) and the porosity (void ratio) (50%) as those of the composite particles P10 for electrode in example 2, was formed on an aluminum foil (collector).

[Producing of Measurement Cell for Internal Resistance (Impedance) Measurement Test of Composite Particles]

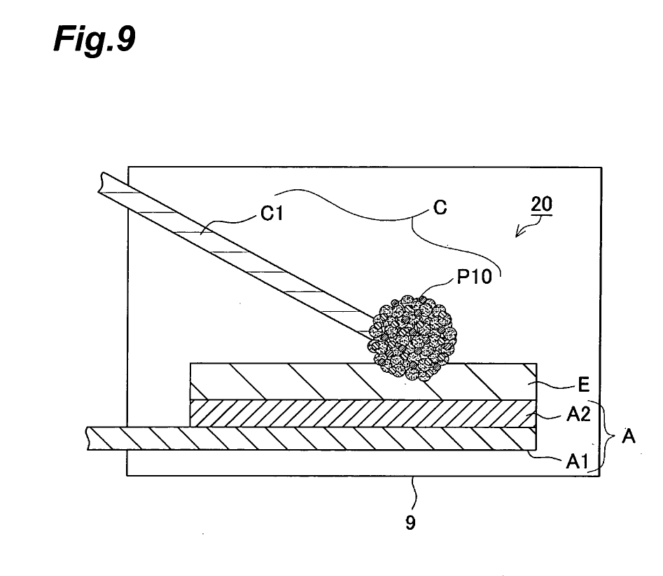

In order to measure the internal resistance (impedance) of the composite particle P10 of example 1, a measurement cell shown in FIG. 9 was produced. FIG. 9 is an illustration showing the measuring method of the internal resistance (impedance) of the composite particle for electrode in example 1.

The measurement cell 20 will be described. As shown in FIG. 9, the measurement cell 20 was disposed in a glove box 9. The inside of the glove box 9 was filled with argon gas. As shown in FIG. 9, the measurement cell 20 was constituted of, principally, a cathode C and an anode A opposite to each other and a layer E of electrolyte solution disposed between the anode A and the cathode C.

As shown in FIG. 9, the anode A was constituted of a metallic lithium foil A2 (film thickness: 200 μm, area of the electrode: circular of diameter 15 mm) and a terminal A1 of a platinum wire connected to the rear surface of the metallic lithium foil A2 (the surface at the side which is not brought into contact with the layer E of the electrolyte solution). Also, as shown in FIG. 9, the cathode C was constituted of the composite particle P10 for electrode of example 1 and a terminal C1 of a platinum wire which was electrically connected to the composite particle P10 for electrode.

The composite particle P10 for electrode and the terminal C1 of a platinum wire were electrically connected to each other in a state that both contact resistance values became the minimum. Also, the composite particle P10 for electrode of the cathode C was impregnated in the layer E of the electrolyte solution, and the position thereof was fixed so that the distance between the metallic lithium foil A2 and the composite particle P10 for electrode was constant (1 cm).

The layer E of electrolyte solution was constituted of electrolyte solution in which LiClO₄ was dissolved in a solvent in which ethylene carbonate and propylene carbonate were mixed at a volume ratio of 3:1 so that the density thereof was 1 mol/L.

[Internal Resistance (Impedance) Measurement Test of Composite Particles]

On each measurement cell, in which the composite particle P10 for electrode of example 1 was used for the electrode, the internal resistance (impedance) was measured when the measuring temperature was room temperature (25° C.).

The internal resistance (impedance) was measured in a manner as described below. That is, on one of the composite particle P10 (1 particle) for electrode of example 1, cyclic voltammetry measurement was performed. Based on this, the equilibrium capacity value of the composite particle P10 for electrode was calculated. Then, on one of the composite particle P10 (1 particle) for electrode of example 1, the impedance was measured; and from the data of the obtained complex impedance plots, the charge transfer resistance value of the composite particle P10 for electrode was calculated as the impedance value. Then, by dividing the impedance value by the equilibrium capacity value, the impedance value normalized by the equilibrium capacity value(=(the impedance value)/(the equilibrium capacity value)) was obtained. The result is shown in table 1. This value is the relative value assuming that the value of the following comparative example 1 is 1.

[Internal Resistance (Impedance) Measurement Test of the Electrode of Comparative Example 1]

On the electrode of the comparative example 1, the internal resistance (impedance) was measured when the measuring temperature was room temperature (25° C.).

The internal resistance (impedance) was measured in a manner as described below. That is, on the active material-containing layer for electrode of comparative example 1, cyclic voltammetry measurement was performed. Based on this, the equilibrium capacity value of the active material-containing layer was calculated. Then, on active material-containing layer, the impedance was measured, and from the data of the obtained complex impedance plots, the charge transfer resistance value of the active material-containing layer was calculated as the impedance value. Then, by dividing the impedance value by the equilibrium capacity value, the impedance value normalized by the equilibrium capacity value (=(the impedance value)/(the equilibrium capacity value)) was obtained. The result is shown in table 1. Assuming that this value is 1, other examples were compared.

[Internal Resistance (Impedance) Measurement Test of Electrode Active Material Comprised in Composite Particle for Electrode of Example 1]

On particles of electrode active material comprised in the composite particle P10 for electrode of example 1, the internal resistance (impedance) was measured when the measurement temperature was room temperature (25° C.).

The measurement of the internal resistance (impedance) was carried out as described below. That is, on one particle of the particles of electrode active material of the composite particle P10 for electrode of example 1 (one particle), cyclic voltammetry measurement was performed; and based on this, the equilibrium capacity value of the particle of the electrode active material was calculated. Then, on one particle of the electrode active material comprised in the composite particle P10 for electrode of example 1 (one particle), the impedance was measured; and from the data of the obtained complex impedance plots, the charge transfer resistance value of the particles of electrode active material was calculated as the impedance value. Then, the impedance value was divided by the equilibrium capacity value; thus, the impedance value normalized based on the equilibrium capacity value (=(the impedance value)/(the equilibrium capacity value)) was obtained. The result of this is shown table 1. The values in Table 1 are dimensionless values since calculation was made assuming that the value of the comparative example 1 was 1 (reference).

TABLE 1

| | Impedance normalized based |
|---|---|
| | on equilibrium capacity |
| Example 1 (composite | 0.07 |
| particles) | |
| Active | 1.00 |
| material-containing | |
| layer of the comparative | |
| example 1 | |
| Active material particle | 0.28 |

As demonstrated in the result shown in Table 1, it was confirmed that, when the electrode was produced from the composite particles of examples 1 to 3, compared to the internal resistance of the active material-containing layer for electrode produced in accordance with the conventional producing method, the internal resistance of the active material-containing layer was satisfactorily low.

Further, as demonstrated by the result shown in Table 1, it was confirmed that, even when the binder was comprised, the composite particles of the examples 1 to 3, the internal resistance value thereof was lower than the internal resistance value of the used electrode active material itself.

### Example 4

(1) Producing of Composite Particle

First of all, in accordance with the following procedure, a composite particle, which can be used for forming the active material-containing layer for the cathode of a lithium ion secondary cell, was produced in accordance with the above-described granulating step. The composite particle P10 was constituted of an electrode active material for the cathode (92% by mass), a conductive additive (4.8% by mass) and a binder (3.2% by mass).

As for the electrode active material for the cathode, from the composite metal oxide expressed by a general formula: LiₓMn_{y}Ni_{z}Co_{1-x-y}O_{w}, particles of a composite metal oxide (BET specific surface area: 0.55 m²/g, average particle diameter: 12 μm), which satisfies the conditions of x=1, y=0.33, z=0.33 and w=2, was used. As for the conductive additive, acetylene black was used. Further, as for the binder, polyvinyliden fluoride was used.

First of all, in the stock solution preparing step, a “stock solution” (acetylene black of 3% by mass, polyvinyliden fluoride of 2% by mass) was prepared by dispersing acetylene black in the solution in which polyvinyliden fluoride was dissolved in N,N-dimethylformamide [(DMF): solvent].

Then, in the fluidized bed-forming step, airflow of the air was generated within a container, which had the same structure as that of the fluidizing bathe 5 shown in FIG. 3, fine particles of a composite metal oxide were thrown in to form a fluidized bed. Then, in the spray-drying step, the above-described stock solution was sprayed to the fine particles of the composite metal oxide in the state of fluidized bed to allow the solution adhering to the surface of fine particles. By maintaining the temperature of the ambient atmosphere in which the fine particles to be sprayed were placed to a fixed level, substantially simultaneously with the spraying, N,N-dimethylformamide was removed from the surface of fine particles. Thus, the acetylene black and the polyvinyliden fluoride were brought into a close contact with the surface of fine particles; thus, the composite particle P10 for electrode (average particle diameter: 200 μm) was obtained.

The amount of the electrode active material, the conductive additive and the binder used in the granulating step was controlled respectively so that the mass ratio of these components within the finally obtained composite particles P10 for electrode agreed with the above-described values.

(2) Producing of Electrode (Cathode)

The electrode (cathode) was produced in accordance with the above-described dry method. First of all, using a heat roll press machine, which has the same structure as that shown in FIG. 4, the composite particle P10 (average particle diameter: 200 μm) was thrown thereinto; thus, sheet (width: 10 cm), which serves as the active material-containing layer, was produced (sheet forming step). Here, the heating temperature was 120° C.; and the pressurizing condition was 200 kgf/cm line pressure. Then, this sheet was punched out to obtain a disk-like active material-containing layer (diameter: 15 mm).

Then, a hot melt conductive layer (thickness: 5 μm) was formed on one surface of a disk-like collector (aluminum foil, diameter: 15 mm, thickness: 20 μm). The hot melt conductive layer is a layer (acetylene black: 20% by mass, polyvinyliden fluoride: 80% by mass), which consists of the same conductive additive (acetylene black) as that used for producing the composite particle and the same binder (polyvinyliden fluoride) as that used for producing the composite particle.

Then, the previously produced sheet, which serves as the active material-containing layer, was disposed on the hot melt conductive layer and bonded by means of thermo compression. As for the conditions of thermo compression bonding, thermo compression bonding time: for one minute, heating temperature was 180° C., and the pressurizing condition was 30 kgf/cm². Thus, the electrode (cathode) having the active material-containing layer of thickness: 100 μm, active material supporting amount: 30 mg/cm², and void percent: 25% by volume was obtained.

### Example 5

(1) Producing of Composite Particle

First of all, in accordance with the procedure described below, a composite particle, which can be used for forming the active material-containing layer for the anode of lithium ion secondary cell, was produced in accordance with the granulating step. The composite particle P10 was constituted of an electrode active material for the anode (88% by mass), a conductive additive (4% by mass) and a binder (8% by mass).

As for the electrode active material for the anode, a particle of an artificial graphite, which is a fibrous black lead material (BET specific surface area: 1.0 m²/g, average particle diameter: 19 μm) was used. As for the conductive additive, acetylene black was use. Further, as for the binder, polyvinyliden fluoride was used.

First of all, in the stock solution preparing step, a “stock solution” (acetylene black of 3% by mass, polyvinyliden fluoride of 2% by mass) was prepared by dispersing acetylene black into the solution in which polyvinyliden fluoride was dissolved in N,N-dimethylformamide [(DMF): solvent].

Then, in the fluidized bed-forming step, airflow of the air was generated within a container, which had the same structure as that of the fluidizing bathe 5 shown in FIG. 3, fine particles of a composite metal oxide were thrown in to form a fluidized bed. Then, in the spray-drying step, the above-described stock solution was sprayed to the fine particles of the composite metal oxide in the state of fluidized bed to allow the solution adhering to the surface of fine particles. By maintaining the temperature of the ambient atmosphere in which the fine particles to be sprayed were placed to a fixed level, substantially simultaneously with the spraying, N,N-dimethylformamide was removed from the surface of fine particles. Thus, the acetylene black and the polyvinyliden fluoride were brought into a close contact with the surface of fine particles; thus, the composite particle P10 for electrode (average particle diameter: 200 μm) was obtained.

The amount of the electrode active material, the conductive additive and the binder used in the granulating step was controlled respectively so that the mass ratio of these components within the finally obtained composite particle P10 for electrode agreed with the above-described values.

(2) Producing of Electrode (Anode)

The electrode (anode) was produced in accordance with the above-described dry method. First of all, using a heat roll press machine, which has the same structure as that shown in FIG. 4, the composite particle P10 (average particle diameter: 200 μm) was thrown thereinto, sheet (width: 10 cm), which serves as the active material-containing layer, was produced (sheet forming step). Here, the heating temperature was 120° C.; and the pressurizing condition was 200 kgf/cm line pressure. Then, this sheet was punched out to obtain a disk-like active material-containing layer (diameter: 15 mm).

Then, a hot melt conductive layer (thickness: 5 μm) was formed on one surface of a disk-like collector (copper foil, diameter: 15 mm, thickness: 20 μm). The hot melt conductive layer is a layer (acetylene black: 30% by mass, polyvinyliden fluoride: 70% by mass), which consists of the same conductive additive (acetylene black) as that used for producing the composite particle and the binder (methyl methacrylate).

Then, the sheet previously produced, which served as the active material-containing layer, was disposed on the hot melt conductive layer and bonded by means of thermo compression. As for the conditions of thermo compression bonding, thermo compression bonding time: for 30 seconds, heating temperature was 100° C., and the pressurizing condition was 10 kgf/cm². Thus, the electrode (anode) of the active material-containing layer, of which thickness: 100 μm, active material: 15 mg/cm², and void percent: 25% by volume was obtained.

### Comparative Example 4

An electrode (cathode) was produced in accordance with the following conventional electrode forming procedure (wet processing). As for the constituent material for the electrode, the same electrode active material, conductive additive and binder as those used in example 4 respectively were used, and controlled so that mass of the electrode active material:mass of the conductive additive:mass of the binder was the same as those in example 4. The used collector (provided with a hot melt layer) was also the same as that used in example 4.

First of all, the binder was dissolved in N-methyl pyrrolidone (NMP) to prepare the binder solution (binder density with reference to the total mass of the solution: 5% by mass). Then, the electrode active material and the conductive additive were thrown into the binder solution at the above-described ratio and mixed by a hyper mixer to obtain the coating liquid. Then, the coating liquid was applied on the hot melt layer of the collector for the cathode by a doctor blade method. Then, the liquid film of the coating liquid formed on the collector for the cathode was dried.

Then, the obtained collector for the cathode in a state that the liquid film was dried was extended by applying pressure using a roller press machine. Here, the heating temperature was 180° C., heating time was for one minute, and the pressurizing condition was 30 kgf/cm². Thus, the electrode (cathode) having the active material-containing layer with thickness: 100 μm, active material supporting amount: 30 mg/cm² and void percent: 25% by volume was obtained.

### Comparative Example 5

An electrode (anode) was produced in accordance with the following conventional electrode forming procedure (wet processing). As for the constituent material for electrode, the same electrode active material, conductive additive and binder as those used in example 4 respectively were used, and controlled so that mass of the electrode active material:mass of the conductive additive:mass of the binder was the same as those in example 5. The used collector (provided with a hot melt layer) was also the same as that used in example 5.

First of all, the binder was dissolved in N-methyl pyrrolidone (NMP) to prepare the binder solution (binder density with reference to the total mass of the solution: 5% by mass). Then, the electrode active material and the conductive additive were thrown into the binder solution at the above-described ratio and mixed by a hyper mixer to obtain the coating liquid. Then, the coating liquid was applied on the hot melt layer of the collector for the anode by a doctor blade method. Then, the liquid film of the coating liquid formed on the collector for the anode was dried.

Then, the obtained collector for the anode in a state that the liquid film was dried was extended by applying pressure using a roller press machine. Here, the heating temperature was 100° C., heating time was for 30 seconds, and the pressurizing condition was 10 kgf/cm². Thus, the electrode (anode) having the active material-containing layer with thickness: 100 μm, active material supporting amount: 15 mg/cm² and void percent: 25% by volume was obtained.

[Electrode Characteristics Assessment Test]

Electrochemical cells were produced by using each of electrodes in examples 4 and 5 and comparative examples 4 and 5 as a “test electrode (work electrode)” and a lithium metal foil (diameter: 15 mm, thickness: 100 μm) as a counter electrode, and the following assessment tests were made to assess electrode characteristics of each electrode (test electrode). The results of the assessment test are shown in table 2.

(1) Preparation of Electrolyte Solution

The electrolyte solution for forming the electrolyte layer was prepared in accordance with the preparing procedure. That is, LiClO₄ was dissolved in the solvent [solvent in which ethylene carbonate (EC) and diethyl carbonate (DEC) were mixed at volume ratio 1:1] so that volume mole concentration was 1 mol/L.

(2) Producing of Electrochemical Cell for Electrode Characteristics Assessment Test

First of all, the test electrode and the counter electrode were set opposing to each other, and a separator (diameter: 15 mm, thickness: 30 μm) formed of polyethylene porous film was disposed therebetween to form a laminated product (element), in which the anode, the separator and the cathode were built up in this order. A lead (width: 10 mm, length: 25 mm, thickness: 0.50 mm) was connected to each of the anode and the cathode of the laminated product by means of an ultrasonic welding. Then, the laminated product was placed in an airtight container, which served as a mold for the electrochemical cell, and the prepared electrolyte solution was poured, and maintained in a state that a specific pressure was applied thereto from the both sides of the anode and cathode of the laminated product. Thus, electrochemical cell was produced for each test electrode.

(3) Electrode Characteristics Assessment Test

In the case where the test electrode was the cathode (the electrode in example 4 and electrode in comparative example 4), using the redox potential of the lithium metal of the counter electrode as the reference, the potential of the test electrode was polarized in a potential range of +2.5 V to +4.3 V (constant current-constant voltage). The measurement assessment tests were carried out at 25° C.

In the case where the test electrode was the anode (the electrode in example 5 and electrode in comparative example 5), using the redox potential of the lithium metal of the counter electrode as the reference, the potential of the test electrode was polarized in a potential range of +0.01 V to +3 V (constant current-constant voltage). The measurement assessment tests were carried out at 25° C.

From the obtained polarizing characteristics, capacity of active substance (A) (mAh·g⁻¹) of the respective electrodes at the point of test and the maximum current density (mA·cm⁻²) capable of pulling out the capacity of active substance (A) were obtained. The results are shown in Table 2.

TABLE 2

| | Capacity of active | Maximum current density |
|---|---|---|
| | substance (A) at the | capable of pulling out the |
| | point of test/ | capacity of active substance |
| | mAh · g⁻¹ | (A)/mA · cm⁻² |
| Example 4 | 155 | 9.2 |
| Example 5 | 311 | 8.8 |
| Comparative | 155 | 0.4 |
| example 4 | | |
| Comparative | 305 | 0.8 |
| example 5 | | |

From the results shown in Table 2, the following fact was confirmed. That is, compared to the electrodes of comparative examples 4 and 5, in the electrodes of examples 4 and 5, the maximum current density capable of pulling out the capacity of active substance (A) is larger; and accordingly, they have superior output characteristics. Based on the above result, it is understood that, in the active material-containing layer for electrodes in examples 4 and 5, the electrode active material and the conductive additive are electrically bound to each other without being isolated from each other and, therefore, satisfactory electron conduction network and ion conduction network are formed.

(Observation of Section of Active Material-Containing Layer)

Pieces of a part of the electrodes of *example 4 and *comparative example 4 punched out in a rectangular shape (5 mm×5 mm) were obtained. On the active material-containing layer of the respective pieces of electrodes *example 4 and *comparative example 4, resin-filling treatment (resin: epoxy) was made, and further, the surface of the obtained active material-containing layers was polished. Then, using a microtome, from each of the pieces of the electrodes in *example 4 and *comparative example 4, measurement samples (0.1 mm×0.1 mm) for observing by means of an SEM photograph and a TEM photograph were obtained. On each of the measurement samples, SEM photograph and TEM photograph were taken.

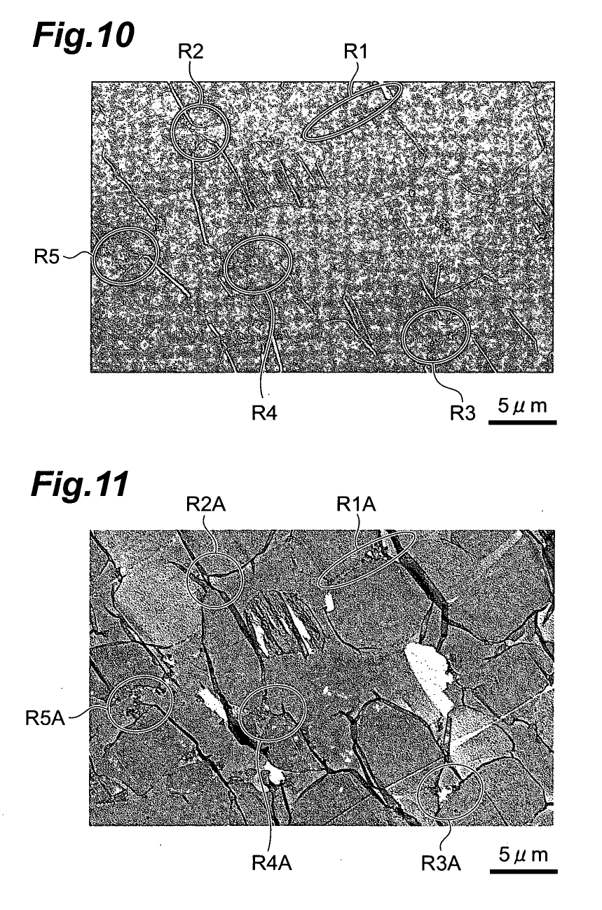

SEM photographs and TEM photographs of the active material-containing layer for electrode in *example 4 are shown in FIGS. 10 to 15. And SEM photographs and TEM photographs of the active material-containing layer for electrode in *comparative example 4 are shown in FIGS. 16 to 21.

FIG. 10 is an SEM photograph showing a section of the active material-containing layer for electrode (electric double layered capacitor), which was formed in accordance with the forming method (dry method) of the invention. FIG. 11 is a TEM photograph showing a section (a portion identical to the portion shown in FIG. 10) of the active material-containing layer for electrode (electric double layered capacitor) formed in accordance with the forming method (dry method) of the invention.

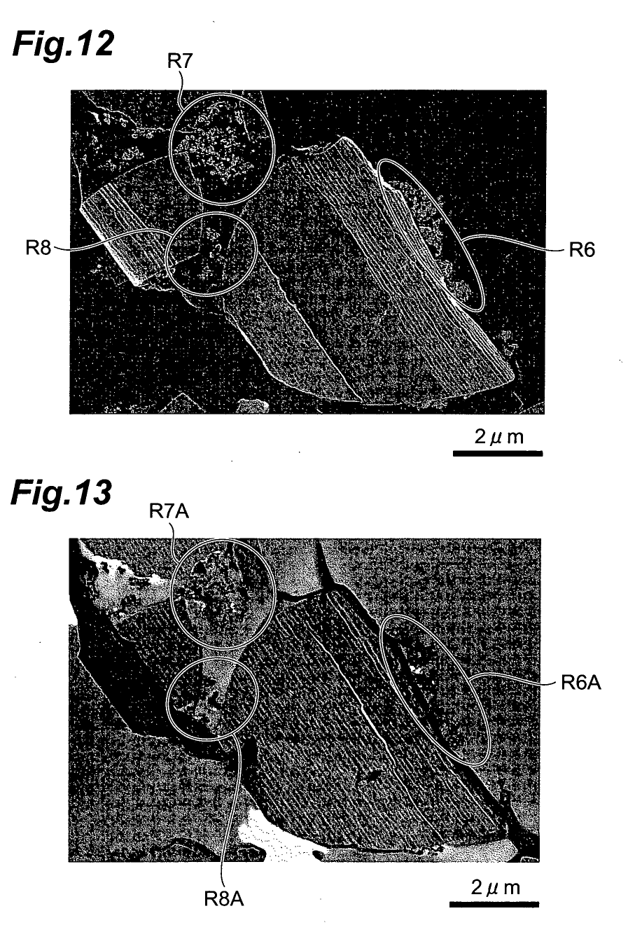

FIG. 12 is an SEM photograph showing a section of the active material-containing layer for electrode (electric double layered capacitor), which was formed in accordance with the forming method (dry method) of the invention. FIG. 13 is a TEM photograph showing a section (a portion identical to the portion shown in FIG. 12) of the active material-containing layer for electrode (electric double layered capacitor) formed in accordance with the forming method (dry method) of the invention.

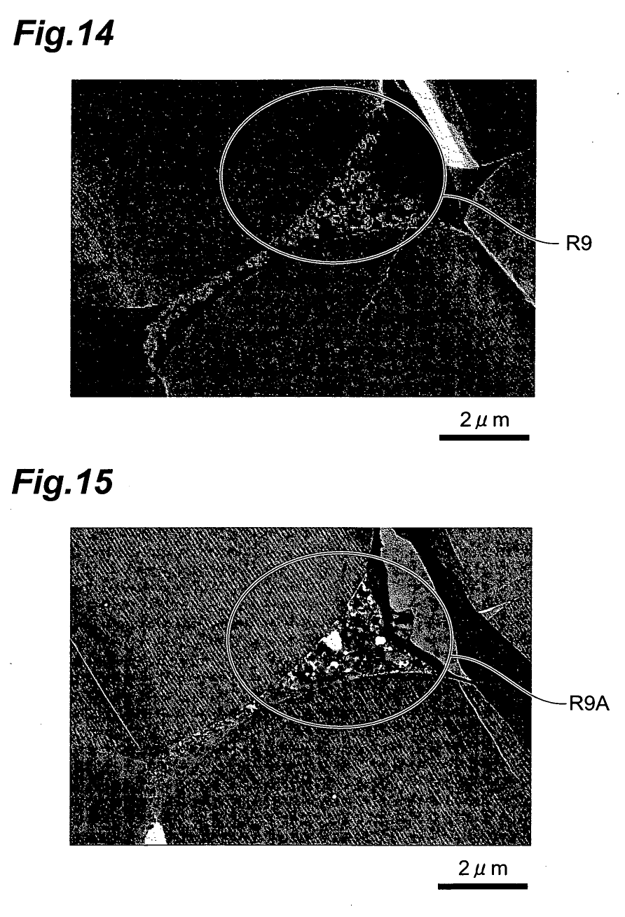

FIG. 14 is an SEM photograph showing a section of the active material-containing layer for electrode (electric double layered capacitor), which was formed in accordance with the forming method (dry method) of the invention. FIG. 15 is a TEM photograph showing a section (a portion identical to the portion shown in FIG. 14) of the active material-containing layer for electrode (electric double layered capacitor) formed in accordance with the forming method (dry method) of the invention.

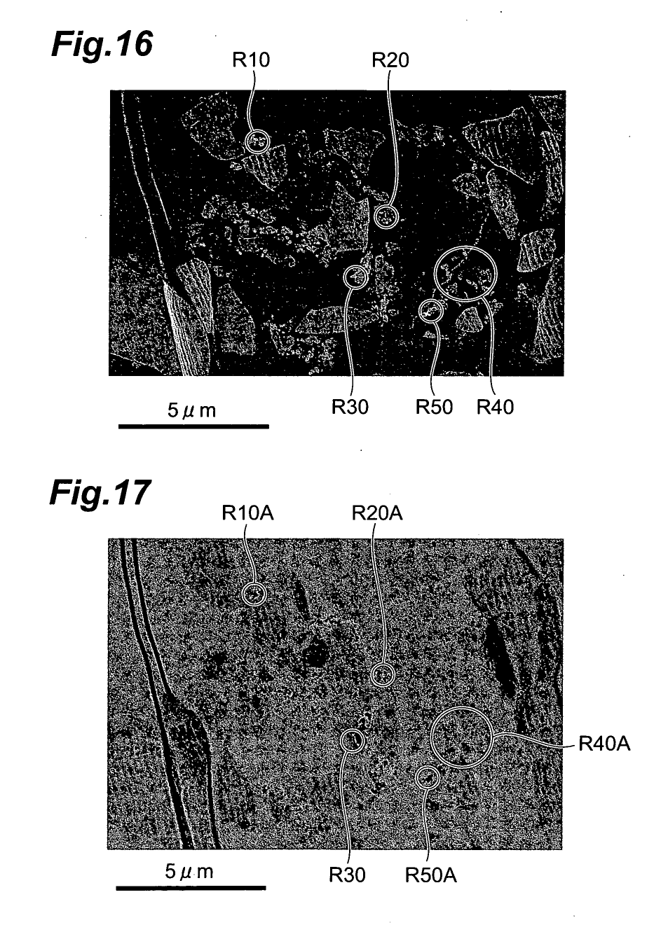

FIG. 16 is an SEM photograph showing a section of an active material-containing layer for electrode (electric double layered capacitor), which was formed in accordance with the conventional producing method (wet process). FIG. 17 is a TEM photograph showing a section (a portion identical to the portion shown in FIG. 16) of an active material-containing layer for electrode (electric double layered capacitor) formed in accordance with the conventional producing method (wet process).

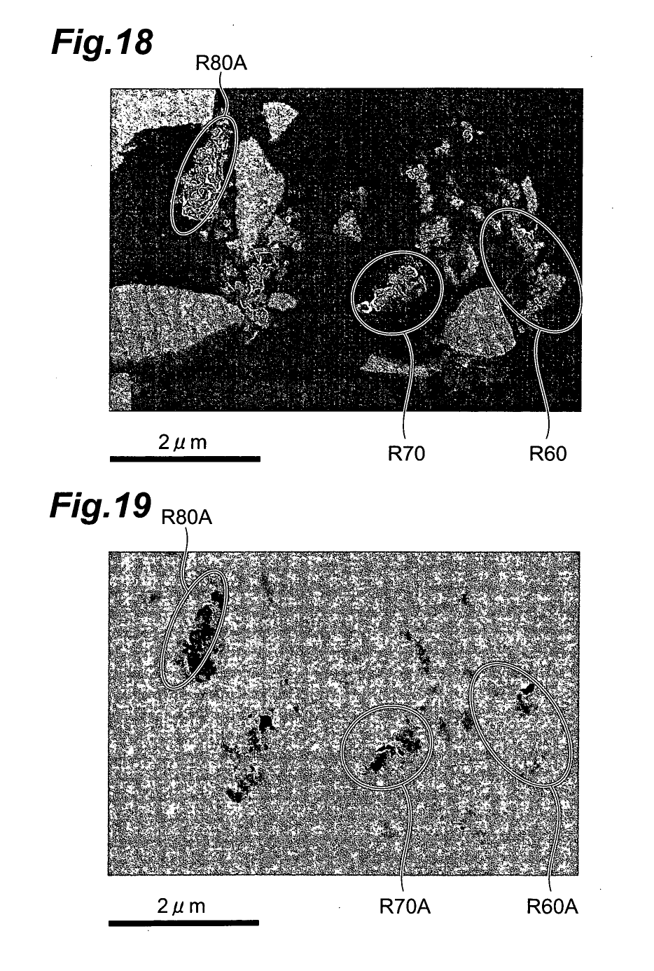

FIG. 18 is an SEM photograph showing a section of an active material-containing layer for electrode (electric double layered capacitor), which was formed in accordance with the conventional producing method (wet process). FIG. 19 is a TEM photograph showing a section (a portion identical to the portion shown in FIG. 18) of an active material-containing layer for electrode (electric double layered capacitor) formed in accordance with the conventional producing method (wet process).

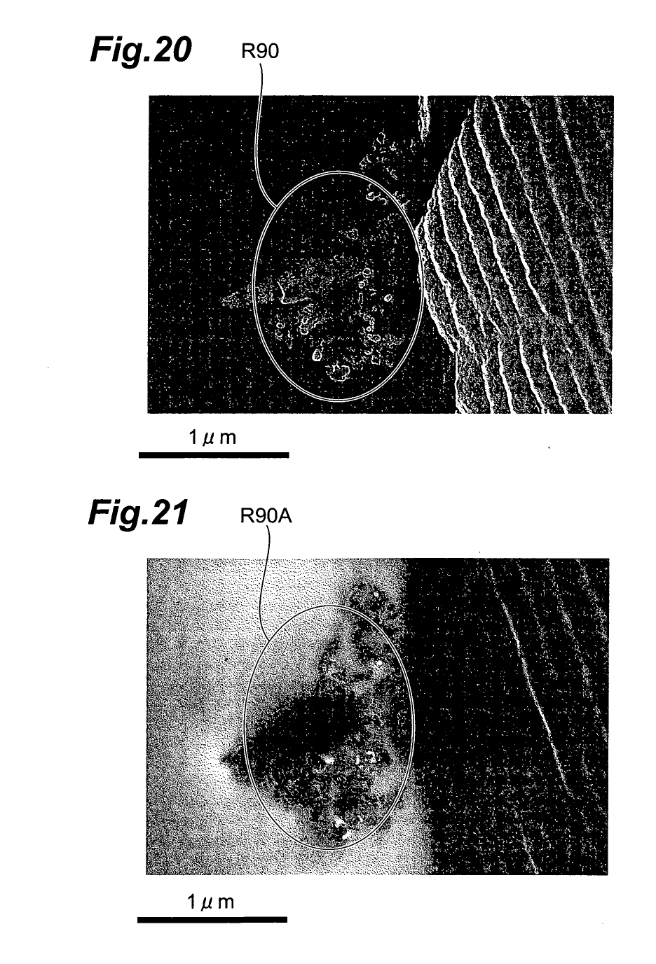

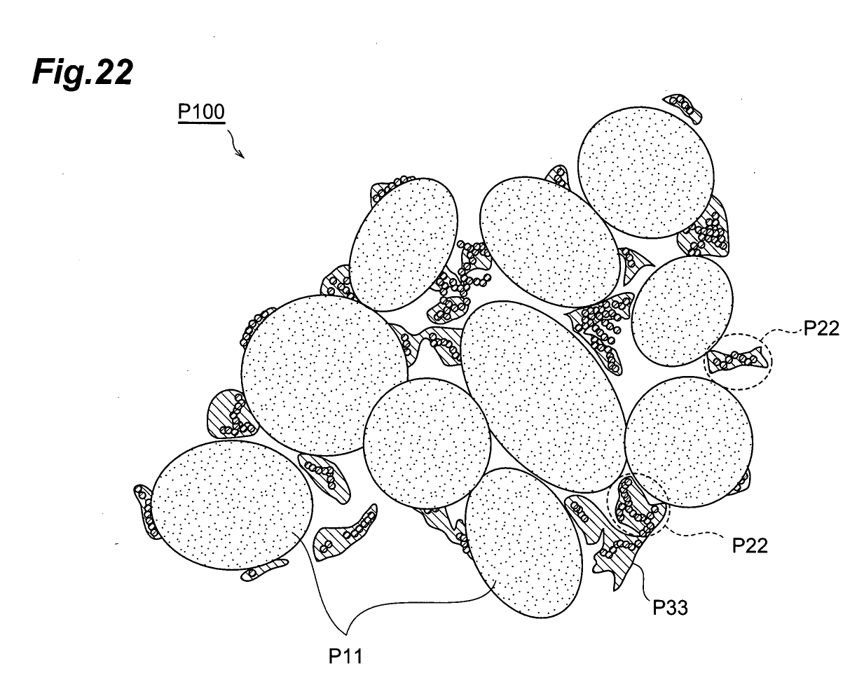

FIG. 20 is an SEM photograph showing a section of an active material-containing layer for electrode (electric double layered capacitor), which was formed in accordance with the conventional producing method (wet process). FIG. 21 is a TEM photograph showing a section (a portion identical to the portion shown in FIG. 20) of an active material-containing layer for electrode (electric double layered capacitor) formed in accordance with the conventional producing method (wet process).

As demonstrated by the results shown in FIGS. 10 to 15, it was confirmed that the electrode of *example 4 has the following structure. That is, for example, from the observation result of photographed areas of R1 to R5 in FIG. 10 and the photographed areas of R1A to R5A in FIG. 11 (the same portions as those of R1 to R5 in FIG. 10 respectively), it was confirmed that neighboring activated carbon particles were electrically and physically connected to each other by the agglomerate consisting of the conductive additive and the binder, and that satisfactory electron conduction network and ion conduction network were formed.

The internal structure of the above active material-containing layer was confirmed more clearly from the observation result of photographed areas of R6 to R8 in FIG. 12 and photographed areas of R6A to R8A in FIG. 13 (the same portion of R6 to R8 in FIG. 12 respectively), and from the observation result of photographed area of R9 in FIG. 14 and photographed area of R9A in FIG. 15 (the same portion of R9 in FIG. 14), which are the photographs of which magnification are changed.

On the other hand, as demonstrated by the results shown in FIGS. 16 to 17, it was confirmed that the electrode of *comparative example 4 had the following structure. That is, for example, from the observation result of photographed areas of R10 to R50 in FIG. 16 and the photographed areas of R10A to R50A in FIG. 17 (the same portions as those of R10 to R50 in FIG. 16 respectively), it was clearly observed that the agglomerate consisting of the conductive additive and the binder existed being electrically and physically isolated from the activated carbon particle, and compared to the active material-containing layer in *example 4, the electron conduction network and the ion conduction network were not formed satisfactorily.

The internal structure of the above active material-containing layer was confirmed more clearly as the observation result of photographed areas of R60 to R80 in FIG. 18 and photographed areas of R60A to R80A in FIG. 19 (the same portion of R60 to R80 in FIG. 18 respectively) and the observation result of photographed area of R90 in FIG. 20 and photographed area of R90A in FIG. 21 (the same portion of R90 in FIG. 20), which are the photographs of which magnification is changed.

### INDUSTRIAL APPLICABILITY

As described above, according to the invention, a composite particle for electrode, which is capable of easily and reliably forming an electrode having superior electrode characteristics even when a binder is used as the constituent material for electrode, can be obtained.

Also, according to the invention, the electrode, of which internal resistance is satisfactorily reduced, and which has superior electrode characteristics capable of easily and satisfactorily increasing the power density of the electrochemical element can be provided.

Further, according to the invention, by using the above electrode, the electrochemical element, which has superior charging/discharging characteristics capable of, even when the load requirements sharply and, in addition, largely changes, satisfactorily responding thereto, can be provided.

Further, according to the invention, the producing method, which is capable of easily and reliably obtaining each of the above composite particles for electrode, electrode and electrochemical element in accordance with the invention, can be provided.

1.-36. (canceled)

37. A composite particle for electrode comprising an electrode active material, a conductive additive having electron conductivity and a binder capable of binding the electrode active material and the conductive additive,
the composite particle for electrode being formed through a granulating step in which the conductive additive and the binder are brought into a close contact with the particle consisting of the electrode active material and integrated with each other, and
the granulating step comprising:
a stock solution preparing step for preparing a stock solution comprising the binder, the conductive additive and a solvent;
a fluidized bed forming step for forming the particle consisting of the electrode active material into a fluidized bed by throwing the particle consisting of the electrode active material into a fluidizing bathe; and
a spray-drying step, in which the stock solution is sprayed into the fluidized bed comprising the particle consisting of the electrode active material, thereby the stock solution is allowed adhering to the particle consisting of the electrode active material and dried to remove the solvent from the stock solution adhered to the surface of the particle consisting of the electrode active material to bring the particle consisting of the electrode active material and the particle consisting of the conductive additive into a close contact with each other by means of the binder.

38. The composite particle for electrode according to claim 37, wherein the binder consists of a conductive polymer.

39. The composite particle for electrode according to claim 38, wherein the composite particle has the ion conductivity.

40. The composite particle for electrode according to claim 38, wherein the composite particle has the electron conductivity.

41. The composite particle for electrode according to claim 37, wherein the composite particle further comprises a conductive polymer.

42. The composite particle for electrode according to claim 37, wherein the electrode active material is an active material usable for at least one of the cathode and the anode of a primary cell or a secondary cell.

43. The composite particle for electrode according to claim 37, wherein the electrode active material is a carbon material or a metal oxide having the electron conductivity usable for the electrodes constituting an electrochemical capacitor.

44. An electrode comprising at least a conductive active material-containing layer comprising, as the structural material, composite particles composed of an electrode active material, a conductive additive having electron conductivity, and a binder capable of binding the electrode active material and the conductive additive, and a current collector situated in electrical contact with the active material-containing layer,
the composite particle being formed through a granulating step in which the conductive additive and the binder are brought into a close contact with the particle consisting of the electrode active material and integrated with each other, and
the electrode active material and the conductive additive being non-isolated and electrically linked with each other in the active material-containing layer.

45. The electrode according to claim 44, wherein the granulating step comprises:
a stock solution preparing step for preparing a stock solution comprising the binder, the conductive additive and a solvent;
a fluidized bed forming step for forming the particle consisting of the electrode active material into a fluidized bed by throwing the particle consisting of the electrode active material into a fluidizing bathe; and
a spray-drying step, in which the stock solution is sprayed into the fluidized bed comprising the particle consisting of the electrode active material, thereby the stock solution is allowed adhering to the particle consisting of the electrode active material and dried to remove the solvent from the stock solution adhered to the surface of the particle consisting of the electrode active material to bring the particle consisting of the electrode active material and the particle consisting of the conductive additive into a close contact with each other by means of the binder.

46. The electrode according to claim 44, wherein thickness T of the active material-containing layer and average particle diameter d of the composite particle comprised in the active material-containing layer satisfy the conditions expressed by following formulas (1) to (3):
0.0005≦(T/d)≦1 (1)
1 μm≦T≦150 μm (2)
1 μm≦d≦2000 μm (3).

47. The electrode according to claim 44, wherein the active material-containing layer further comprises a conductive polymer.

48. The electrode according to claim 47, wherein the conductive polymer has the ion conductivity.

49. The electrode according to claim 44, wherein the composite particle further comprises a conductive polymer.

50. The electrode according to claim 44, wherein the binder consists of a conductive polymer.

51. An electrochemical element comprising at least an anode, a cathode and an electrolyte layer having the ion conductivity and having a structure such that the anode and the cathode are disposed opposite to each other being interposed by the electrolyte layer,
the electrode according to claim 44 being provided as the electrode of one or both of the anode and the cathode.

52. A producing method of a composite particle for electrode,
the method comprising a granulating step for forming a composite particle comprising an electrode active material, a conductive additive and a binder by bringing the conductive additive and the binder capable of binding the electrode active material and the conductive additive into a close contact with a particle consisting of the electrode active material to integrate with each other, and
the granulating step comprising:
a stock solution preparing step for preparing a stock solution comprising the binder, the conductive additive and a solvent;
a fluidized bed forming step for forming the particle consisting of the electrode active material into a fluidized bed by throwing the particle consisting of the electrode active material into a fluidizing bathe; and
a spray-drying step, in which the stock solution is sprayed into the fluidized bed comprising the particle consisting of the electrode active material, thereby the stock solution is allowed adhering to the particle consisting of the electrode active material and dried to remove the solvent from the stock solution adhered to the surface of the particle consisting of the electrode active material to bring the particle consisting of the electrode active material and the particle consisting of the conductive additive into a close contact with each other by means of the binder.

53. The producing method of a composite particle for electrode according to claim 52, wherein, in the granulating step, the temperature within the fluidizing bathe is controlled to 50° C. or more and melting point or less of the binder.

54. The producing method of a composite particle for electrode according to claim 52, wherein, in the granulating step, the airflow generated within the fluidizing bathe is an airflow formed of air, nitrogen gas or inactive gas.

55. The producing method of a composite particle for electrode according to claim 53, wherein the solvent comprised in the stock solution is capable of dissolving or dispersing the binder as well as capable of dispersing the conductive additive.

56. The producing method of a composite particle for electrode according to claim 52, wherein a conductive polymer is used as the binder.

57. The producing method of a composite particle for electrode according to claim 53, wherein a conductive polymer is further dissolved in the stock solution.

58. The producing method of a composite particle for electrode according to claim 56, wherein the conductive polymer has the ion conductivity.

59. The producing method of a composite particle for electrode according to claim 56, wherein the conductive polymer has the electron conductivity.

60. The producing method of a composite particle for electrode according to claim 52, wherein the electrode active material is an active material usable for at least one of the cathode and the anode of a primary cell or a secondary cell.

61. The producing method of a composite particle for electrode according to claim 52, wherein the electrode active material is a carbon material or a metal oxide having electron conductivity usable for an electrode constituting an electrochemical capacitor.

62. A producing method of an electrode comprising at least a conductive active material-containing layer which comprises an electrode active material, and a current collector disposed in a state being in electrically contact with the active material-containing layer,
the method comprising:
a granulating step of forming a composite particle comprising an electrode active material, a conductive additive and a binder by bringing the conductive additive and the binder capable of binding the electrode active material and the conductive additive into a close contact with the particle consisting of the electrode active material to integrate with each other; and
a forming step of an active material-containing layer for forming the active material-containing layer in a portion of the collector to be formed with the active material-containing layer using the composite particle, and
the granulating step comprising:
a stock solution preparing step for preparing a stock solution comprising the binder, the conductive additive and a solvent;
a fluidized bed forming step for forming the particle consisting of the electrode active material into a fluidized bed by throwing the particle consisting of the electrode active material into a fluidizing bathe; and
a spray-drying step, in which the stock solution is sprayed into the fluidized bed comprising the particle consisting of the electrode active material, thereby the stock solution is allowed adhering to the particle consisting of the electrode active material and dried to remove the solvent from the stock solution adhered to the surface of the particle consisting of the electrode active material to bring the particle consisting of the electrode active material and the particle of the conductive additive into a close contact with each other by means of the binder.

63. The producing method of an electrode according to claim 62, wherein, in the granulating step, the temperature in the fluidizing bathe is controlled to 50° C. or more and melting point or less of the binder.

64. The producing method of an electrode according to claim 62, wherein, in the granulating step, the airflow generated within the fluidizing bathe is an airflow formed of air, nitrogen gas, or inactive gas.

65. The producing method of an electrode according to claim 63, wherein the solvent comprised in the stock solution is capable of dissolving or dispersing the binder as well as capable of dispersing the conductive additive.

66. The producing method of an electrode according to claim 62, wherein a conductive polymer is further dissolved in the stock solution.

67. The producing method of an electrode according to claim 62, wherein a conductive polymer is used as the binder.

68. The producing method of an electrode according to claim 66, wherein the conductive polymer has the ion conductivity.

69. The producing method of an electrode according to claim 62, wherein the forming step of the active material-containing layer comprises:
a sheet forming step in which sheet is formed by carrying out a heat treatment and a pressure treatment on a fine particle at least comprising the composite particle to obtain a sheet comprising at least the composite particle; and
a disposing step of the active material-containing layer for disposing the sheet on the collector as the active material-containing layer.

70. The producing method of an electrode according to claim 62, wherein the forming step of the active material-containing layer comprises:
a coating liquid-preparing step for preparing a coating liquid for forming an electrode by adding the composite particle to a liquid capable of dispersing or kneading the composite particle;
a step for applying the coating liquid for forming an electrode to a portion of the collector to be formed with the active material-containing layer; and
a step for solidifying the liquid film of the coating liquid for forming an electrode applied to a portion of the collector to be formed with the active material-containing layer.

71. The producing method of an electrode according to claim 62, wherein, in the forming step of an active material-containing layer, thickness T of the active material-containing layer and average particle diameter d of the composite particles comprised in the active material-containing layer satisfy the conditions expressed by following formulas (1) to (3):
0.0005≦(T/d)≦1 (1)
1 μm≦T≦150 μm (2)
1 μm≦d≦2000 μm (3).

72. A producing method of an electrochemical element provided with at least an anode, a cathode and an electrolyte layer having the ion conductivity, and having a structure such that the anode and the cathode are disposed opposite to each other being interposed by the electrolyte layer,
an electrode produced in accordance with the producing method of the electrode according to claim 62 being used as the electrode for one or both of the anode and the cathode.
